(19) United States
(12) Patent Application Publication
(10) Pub. No.: US 2015/0140487 A1
(43) Pub. Date: May 21, 2015

(54) YELLOW TONER

(71) Applicant: CANON KABUSHIKI KAISHA, Tokyo (JP)

(72) Inventors: Takeshi Sekiguchi, Tokyo (JP); Shosei Mori, Hiratsuka-shi (JP); Taichi Shintou, Saitama-shi (JP); Yuko Katsumoto, Yokohama-shi (JP); Takayuki Ujifusa, Ashigarakami-gun (JP); Takeshi Miyazaki, Ebina-shi (JP)

(21) Appl. No.: 14/411,340

(22) PCT Filed: Jun. 19, 2013
(86) PCT No.: PCT/JP2013/067582

§ 371 Date: Dec. 24, 2014

(30) Foreign Application Priority Data
Jun. 27, 2012 (JP) 2012-144317

(51) Int. Cl. G03G 9/09; G03G 9/08

(52) U.S. Cl. CPC G03G 9/091; G03G 9/0819
USPC 430/108.23

(57) ABSTRACT

The present invention provides a yellow toner having excellent light resistance. The yellow toner includes toner particles, each of which contains a binder resin, a wax, and a colorant. The colorant is a compound represented by Formula (1).

### TECHNICAL FIELD

The present invention relates to a yellow toner that is used in recording such as electrophotography, electrostatic recording, magnetic recording, or toner jetting.

### BACKGROUND ART

In recent years, color images have become popular, and a demand for high resolution has been increasing. In digital full color copiers and printers, an original color image is subjected to color separation with filters of blue, green, and red, and then a latent image corresponding to the original image is developed using developers of yellow, magenta, cyan, and black. Therefore, the tinting strength of each colorant contained in the developer of each color highly affects the image quality.

In addition, the reproducibility in color space, such as the Japan Color standard in the printing industry and Adobe RGB in the DeskTop Publishing (DTP), is an important factor. The reproducibility in color space is enhanced by using a dye having a broad color gamut, as well as an improvement in dispersibility of pigment.

Compounds having isoindolinone, quinophthalone, isoindoline, anthraquinone, anthrone, xanthene, or pyridoneazo skeletons are known as typical examples of a yellow colorant.

In particular, yellow colorants having pyridoneazo skeletons have excellent spectral characteristics, and it has been reported that an image can be displayed with high contrast by using such a colorant in a color filter (see PLT 1).

Compounds having isoindolinone, quinophthalone, isoindoline, anthraquinone, or azo skeletons are known as yellow colorants for toners.

In particular, compounds having azo skeletons, such as C.I. Solvent Yellow 162, have characteristics of high transparence and tinting strength and also excellent light resistance and are therefore known to be suitable as yellow colorants for toners (see PTLs 2 to 4).

However, a yellow toner having further excellent light resistance has been still demanded.

### CITATION LIST

### Patent Literature

PTL 1 Japanese Patent Laid-Open No. 2006-124634
PTL 2 Japanese Patent Laid-Open No. 61-112160
PTL 3 Japanese Patent Laid-Open No. 07-140716
PTL 4 Japanese Patent Laid-Open No. 11-282208

### SUMMARY OF INVENTION

### Technical Problem

The present invention provides a yellow toner having excellent light resistance.

### Solution to Problem

The invention achieves the following features.

That is, the present invention provides a yellow toner including toner particles containing a binder resin, a wax, and a colorant. The colorant is a compound represented by Formula (1).

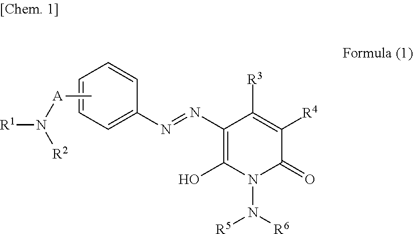

(in Formula (1), R¹ and R² each independently represent a hydrogen atom or an alkyl group; R³ represents an alkyl group, an aryl group, or an amino group; R⁴ represents a hydrogen atom, a cyano group, a carbamoyl group, an alkoxycarbonyl group, or a carboxylic acid amide group; R⁵ and R⁶ each independently represents a hydrogen atom, an alkyl group, or an acyl group or represents an atomic group required to form a nitrogen-containing heterocyclic ring by bonding to each other; and A represents a carbonyl group or a sulfonyl group).

### Advantageous Effects of Invention

The present invention can provide a yellow toner having excellent light resistance.

### BRIEF DESCRIPTION OF DRAWINGS

FIG. 1 is a ¹H-NMR spectrum of compound (1), which is a compound represented by Formula (1) of the present invention used in Example 1, in CDCl₃ at room temperature at 400 MHz.

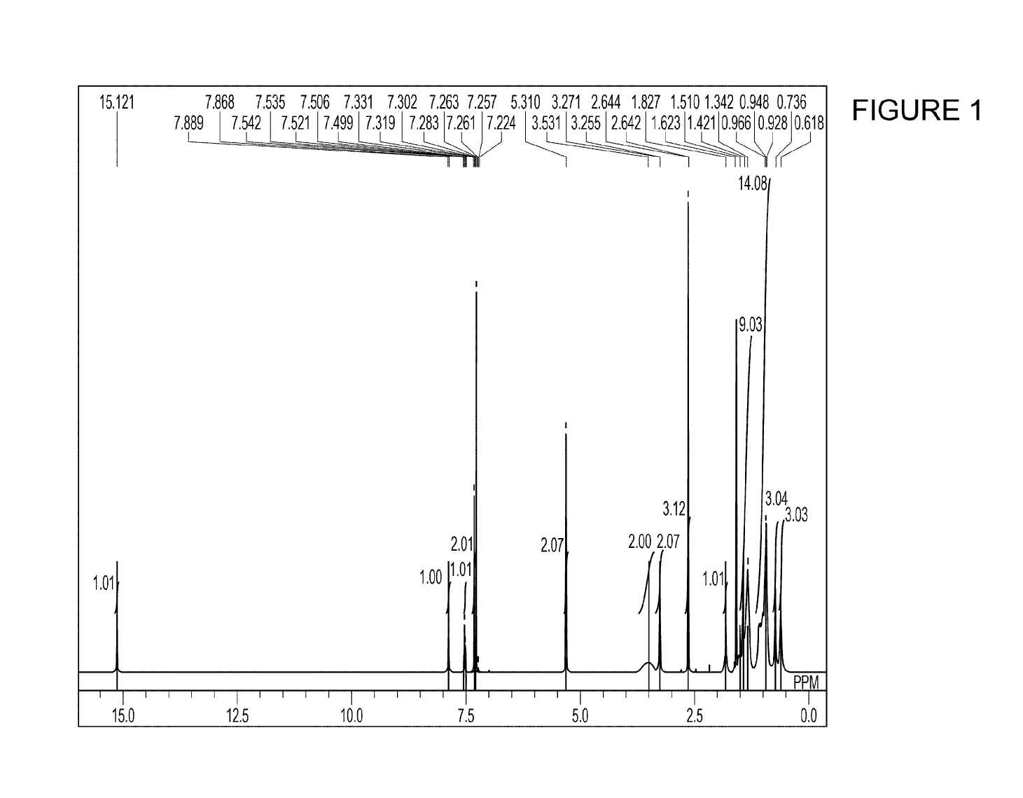

### DESCRIPTION OF EMBODIMENTS

The present invention will now be described by embodiments for implementing the invention.

The present inventors have diligently studied for solving the above-mentioned problems and as a result, have found that a yellow toner including toner particles, each of which contains a binder resin, a wax, and a colorant being a compound represented by Formula (1) has excellent light resistance and have accomplished the present invention.

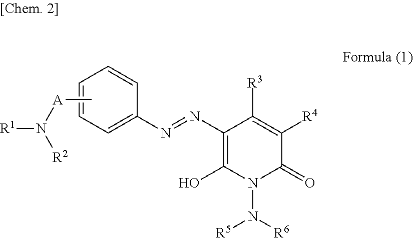

In Formula (1), R¹ and R² each independently represent a hydrogen atom or an alkyl group; R³ represents an alkyl group, an aryl group, or an amino group; R⁴ represents a hydrogen atom, a cyano group, a carbamoyl group, an alkoxycarbonyl group, or a carboxylic acid amide group; R⁵ and R⁶ each independently represents a hydrogen atom, an alkyl group, or an acyl group or represents an atomic group required to form a nitrogen-containing heterocyclic ring by bonding to each other; and A represents a carbonyl group or a sulfonyl group.

### Colorant

The compound represented by Formula (1) used as the colorant will now be described.

The compound represented by Formula (1) is a dye having high light resistance and has high compatibility and affinity to a binder resin contained in a toner.

The alkyl group represented by R¹ or R² in Formula (I) is not specifically limited, and examples thereof include saturated linear, branched, or cyclic primary to tertiary alkyl groups having 1 to 20 carbon atoms, such as methyl, ethyl, n-propyl, iso-propyl, n-butyl, sec-butyl, iso-butyl, tert-butyl, octyl, dodecyl, nonadecyl, cyclobutyl, cyclopentyl, cyclohexyl, methylcyclohexyl, 2-ethylpropyl, 2-ethylhexyl, and ethyl substituted by cyclohexenyl.

In particular, R¹ and R² can each independently represent a hydrogen atom or a methyl, ethyl, n-butyl, sec-butyl, iso-butyl, tert-butyl, n-octyl, dodecyl, cyclohexyl, methylcyclohexyl, 2-ethylpropyl, or 2-ethylhexyl group from the viewpoint of providing excellent light resistance; more preferably a hydrogen atom or a methyl, ethyl, n-butyl, n-octyl, or 2-ethylhexyl group; and most preferably a n-butyl or 2-ethylhexyl group. Excellent light resistance can be provided when R⁴ and R² represent the same alkyl group.

The alkyl group represented by R³ in Formula (1) is not specifically limited, and examples thereof include methyl, ethyl, n-propyl, iso-propyl, n-butyl, sec-butyl, iso-butyl, and tert-butyl groups.

The aryl group represented by R³ is not specifically limited, and examples thereof include a phenyl group.

The amino group represented by R³ is not specifically limited, and examples thereof include amino and dimethylamino groups.

In particular, R³ can represent an alkyl group from the viewpoint of providing excellent light resistance, such as a methyl group.

The alkoxycarbonyl group represented by R⁴ in Formula (1) is not specifically limited, and examples thereof include methoxycarbonyl and ethoxycarbonyl groups.

Examples of the carboxylic acid amide group represented by R⁴ in Formula (1) include carboxylic acid dialkylamide groups such as carboxylic acid dimethylamide and carboxylic acid diethyl amide groups; and carboxylic acid monoalkylamide groups such as carboxylic acid methylamide and carboxylic acid ethylamide groups.

In particular, R⁴ can represent a cyano group from the viewpoint of providing excellent light resistance.

The alkyl group represented by R⁵ or R⁶ in Formula (I) is not specifically limited, and examples thereof include saturated or unsaturated linear, branched, or cyclic primary to tertiary alkyl groups having 1 to 20 carbon atoms, such as methyl, ethyl, n-propyl, iso-propyl, n-butyl, sec-butyl, iso-butyl, tert-butyl, octyl, dodecyl, nonadecyl, cyclobutyl, cyclopentyl, cyclohexyl, methylcyclohexyl, 2-ethylpropyl, 2-ethylhexyl, and ethyl substituted by cyclohexenyl.

The acyl group represented by R⁵ or R⁶ in Formula (I) is not specifically limited, and examples thereof include formyl, acetyl, ethylhexanoyl, benzoyl, and tert-butynoyl groups.

The nitrogen-containing heterocyclic ring formed by R⁵ and R⁶ in Formula (1) bonded to each other is not limited as long as the light resistance is not adversely affected, and examples thereof include pyrrolidine, piperidine, azepane, and azocane rings.

In particular, from the viewpoint of providing excellent light resistance, R⁵ and R⁶ can each independently represent a hydrogen atom or a methyl, ethyl, n-butyl, sec-butyl, iso-butyl, tert-butyl, ethylhexanoyl, benzoyl, or tert-butynoyl group or represent an atomic group required to form a piperidine ring by bonding to each other; more preferably can each independently represent a hydrogen atom or a methyl, ethyl, n-butyl, 2-ethylhexanoyl, benzoyl, or tert-butynoyl group or an atomic group required to form a piperidine ring by bonding to each other.

The compound represented by Formula (1) used in the present invention can be synthesized in accordance with the known method described in International Publication No. WO08/114,886.

Examples of the compound represented by Formula (1) include the following compounds (1) to (30), but the compound represented by Formula (1) used in the present invention is not limited to the following compounds.

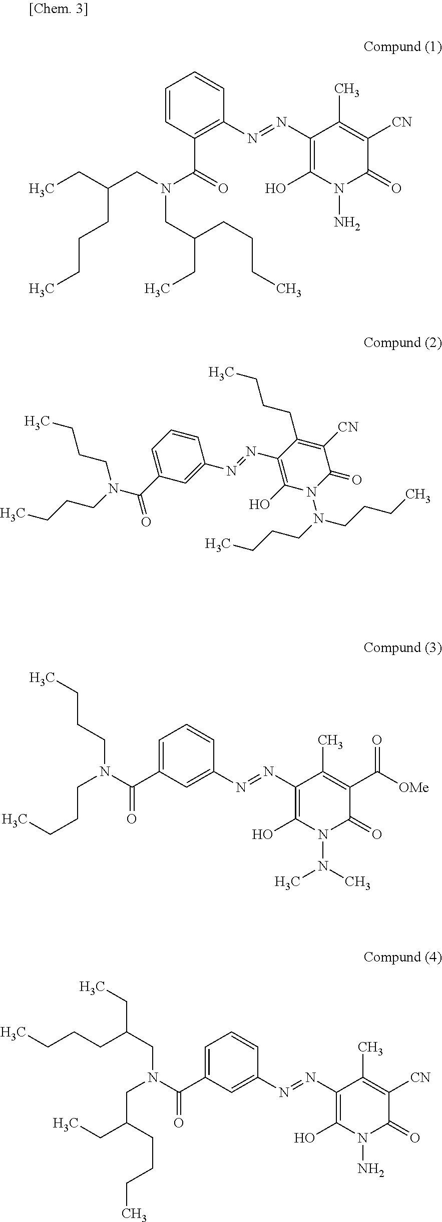

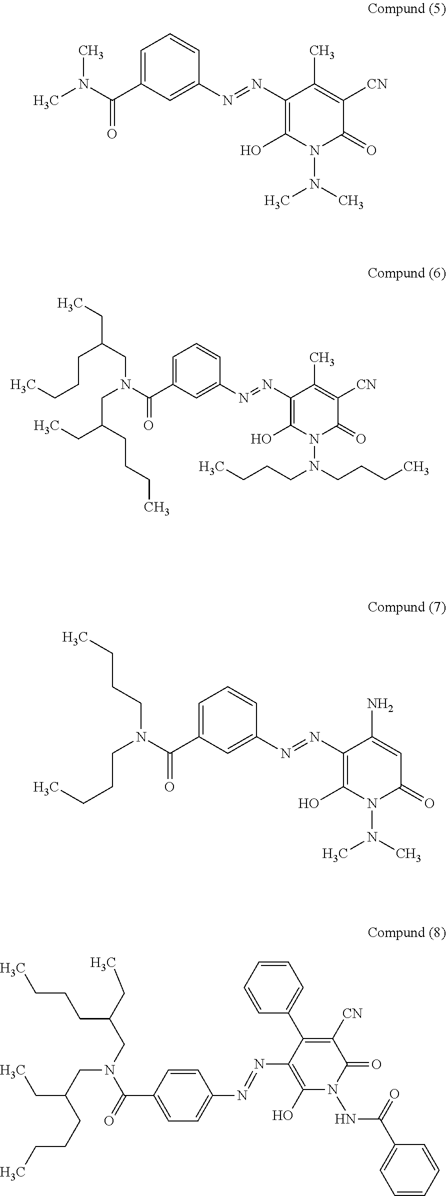

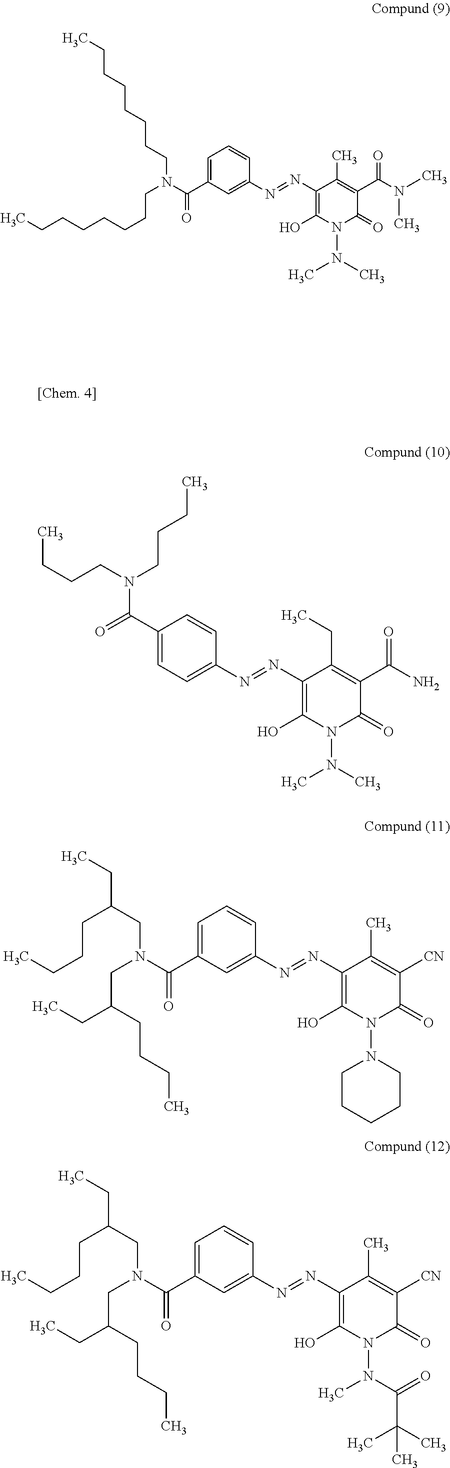

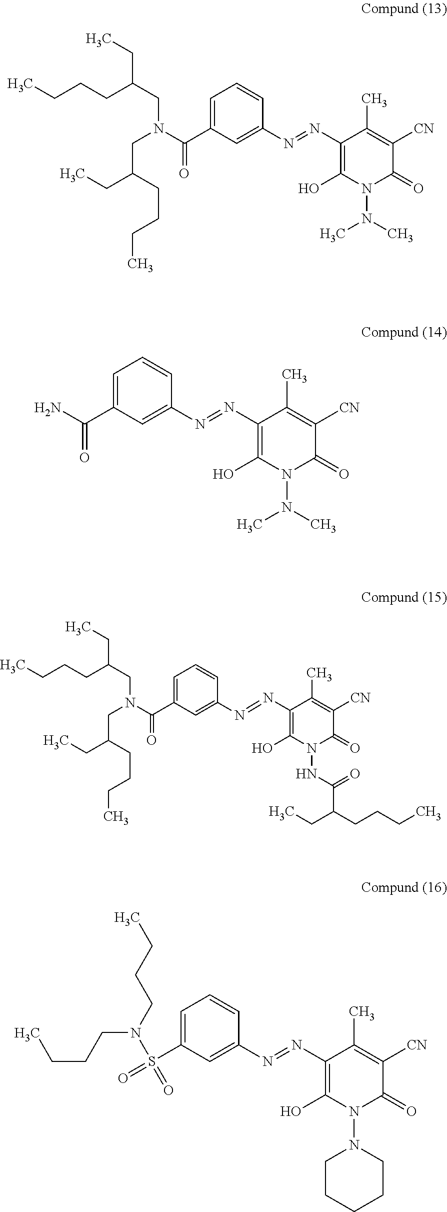

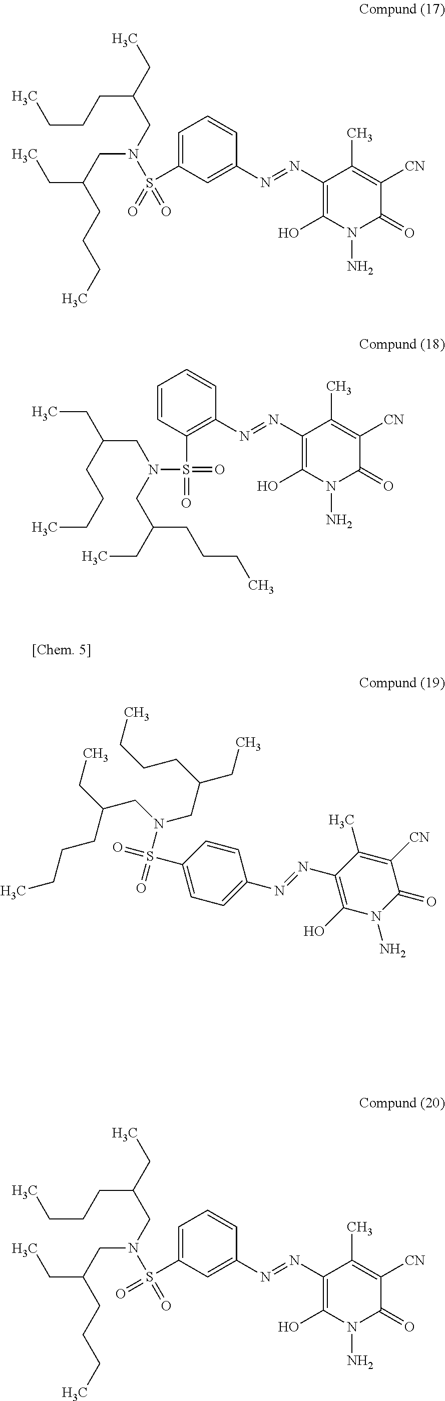 [SMILES: CCCCC(CC)CN(CC(CC)CCCC)S(=O)(=O)c1cccc(/N=N/c2c(C)c(C#N)c(=O)n(N)c2O)c1 ; CCCCC(CC)CN(CC(CC)CCCC)S(=O)(=O)c1ccccc1/N=N/c1c(C)c(C#N)c(=O)n(N)c1O ; CCCCC(CC)CN(CC(CC)CCCC)S(=O)(=O)c1ccc(/N=N/c2c(C)c(C#N)c(=O)n(N)c2O)cc1 ; CCCCC(CC)CN(CC(CC)CCCC)S(=O)(=O)c1cccc(/N=N/c2c(C)c(C#N)c(=O)n(N)c2O)c1]

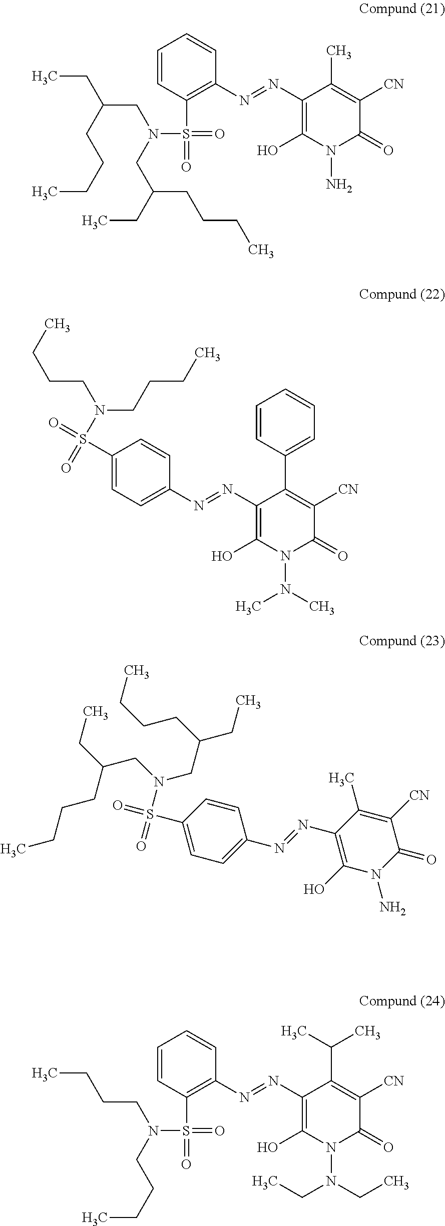 [SMILES: CCCCC(CC)CN(CC(CC)CCCC)S(=O)(=O)c1ccccc1/N=N/c1c(C)c(C#N)c(=O)n(N)c1O ; CCCCN(CCCC)S(=O)(=O)c1ccc(/N=N/c2c(-c3ccccc3)c(C#N)c(=O)n(N(C)C)c2O)cc1 ; CCCCC(CC)CN(CC(CC)CCCC)S(=O)(=O)c1ccc(/N=N/c2c(C)c(C#N)c(=O)n(N)c2O)cc1 ; CCCCN(CCCC)S(=O)(=O)c1ccccc1/N=N/c1c(C(C)C)c(C#N)c(=O)n(N(CC)CC)c1O]

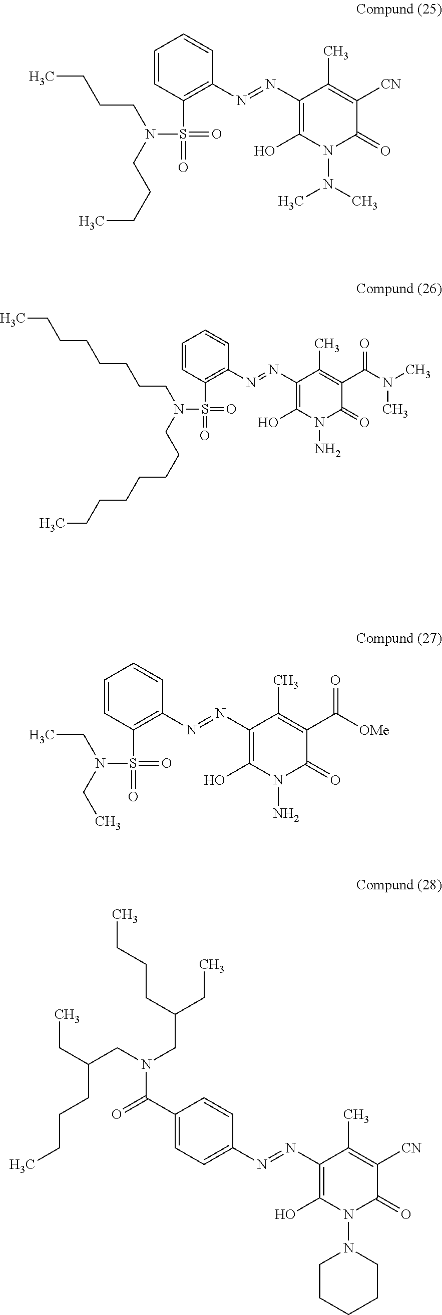

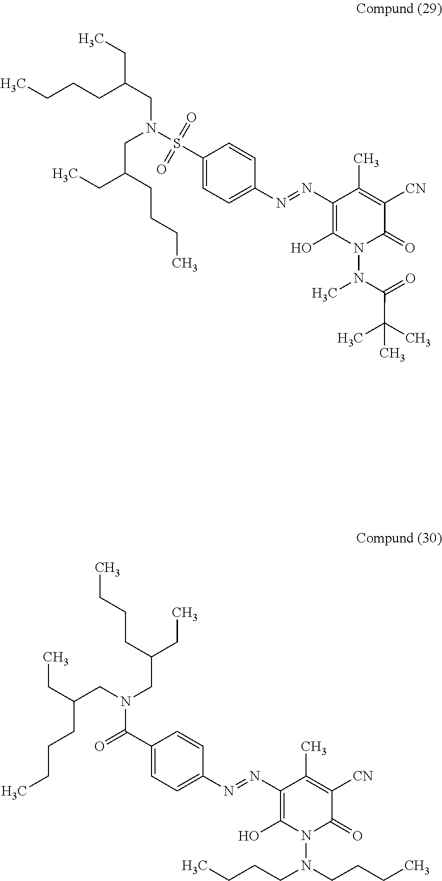 [SMILES: CCCCC(CC)CN(CC(CC)CCCC)S(=O)(=O)c1ccc(/N=N/c2c(C)c(C#N)c(=O)n(N(C)C(=O)C(C)(C)C)c2O)cc1 ; CCCCC(CC)CN(CC(CC)CCCC)C(=O)c1ccc(/N=N/c2c(C)c(C#N)c(=O)n(N(CCCC)CCCC)c2O)cc1]

The content of the compound represented by Formula (1) can be 1 to 20 parts by mass based on 100 parts by mass of the binder resin.

In order to adjust the color tone, the compound represented by Formula (1) may be used alone or in combination with another known yellow dye.

The compound represented by Formula (1) can be used in combination with a general yellow pigment. In particular, a combination with C.I. Pigment Yellow 185, C.I. Pigment Yellow 180, or C.I. Pigment Yellow 155 is effective for forming a satisfactory yellow color. These pigments may be used alone or as a mixture of two or more thereof.

In production of a toner, the colorant may be used in a dispersion state by dispersing the colorant in a dispersion medium.

The use of the compound represented by Formula (1) as a colorant can inhibit an increase in viscosity of the dispersion. The prepared dye dispersion can therefore be readily handled in mixing and granulating steps and can provide a toner in which the colorant is satisfactorily dispersed with a sharp particle distribution.

The dye dispersion will now be described.

The dye dispersion used in the present invention is prepared by dispersing a compound represented by Formula (1) in a dispersion medium being an organic solvent or a mixture of an organic solvent and water. Specifically, for example, a compound represented by Formula (1) and, as necessary, a resin are blended with a dispersion medium and were sufficiently mixed with the dispersion medium by stirring.

The compound can be finely dispersed in a uniform microparticle form by further applying mechanical shearing force to the dispersion with a disperser such as a ball mill, a paint shaker, a dissolver, an attritor, a sand mill, or a high-speed mill.

In the present invention, the content of the compound represented by Formula (1) in the dye dispersion is preferably 1.0 to 30.0 parts by mass, more preferably 2.0 to 20.0 parts by mass, and most preferably 3.0 to 15.0 parts by mass based on 100 parts by mass of the dispersion medium. Within such a range of the content of the compound represented by Formula (1), the viscosity of the dye dispersion can be prevented from increasing, the dispersibility of the compound represented by Formula (1) in the dispersion medium is further enhanced, and a satisfactory tinting strength can be exhibited.

Examples of the organic solvent used as the dispersion medium include alcohols such as methyl alcohol, ethyl alcohol, modified ethyl alcohol, isopropyl alcohol, n-butyl alcohol, isobutyl alcohol, tert-butyl alcohol, sec-butyl alcohol, tert-amyl alcohol, 3-pentanol, octyl alcohol, benzyl alcohol, and cyclohexanol; glycols such as methyl cellosolve, ethyl cellosolve, diethylene glycol, and diethylene glycol monobutyl ether; ketones such as acetone, methyl ethyl ketone, and methyl isobutyl ketone; esters such as ethyl acetate, butyl acetate, ethyl propionate, and cellosolve acetate; hydrocarbon solvents such as hexane, octane, petroleum ether, cyclohexane, benzene, toluene, and xylene; halogenated hydrocarbon solvent such as carbon tetrachloride, trichloroethylene, and tetrabromoethane; ethers such as diethyl ether, dimethyl glycol, trioxane, and tetrahydrofuran; acetals such as methylal and diethyl acetal; organic acids such as formic acid, acetic acid, and propionic acid; and sulfur/nitrogen-containing organic compounds such as nitrobenzene, dimethylamine, monoethanolamine, pyridine, dimethylsulfoxide, and dimethylformamide.

In the production of toner particles by suspension polymerization, the organic solvent used as the dispersion medium can be a polymerizable monomer, in particular, an addition polymerizable monomer. Specific examples of the polymerizable monomer include styrene monomers such as styrene, o-methylstyrene, m-methylstyrene, p-methylstyrene, o-ethylstyrene, m-ethylstyrene, and p-ethylstyrene; acrylic monomers such as methyl acrylate, ethyl acrylate, propyl acrylate, butyl acrylate, octyl acrylate, dodecyl acrylate, stearyl acrylate, behenyl acrylate, 2-ethylhexyl acrylate, dimethylaminoethyl acrylate, diethylaminoethyl acrylate, acrylonitrile, and amide acrylate; methacrylic monomers such as methyl methacrylate, ethyl methacrylate, propyl methacrylate, butyl methacrylate, octyl methacrylate, dodecyl methacrylate, stearyl methacrylate, behenyl methacrylate, 2-ethylhexyl methacrylate, dimethylaminoethyl methacrylate, diethylaminoethyl methacrylate, methacrylonitrile, and amide methacrylate; olefin monomers such as ethylene, propylene, butylene, butadiene, isoprene, isobutylene, and cyclohexene; halogenated vinyls such as vinyl chloride, vinylidene chloride, vinyl bromide, and vinyl iodide; vinyl esters such as vinyl acetate, vinyl propionate, and vinyl benzoate; vinyl ethers such as vinyl methyl ether, vinyl ethyl ether, and vinyl isobutyl ether; and vinyl ketone compounds such as vinyl methyl ketone, vinyl hexyl ketone, and methyl isopropenyl ketone. These monomers may be used alone or in combination of two or more thereof, depending on the use. In particular, styrenes, acrylic monomers, and methacrylic monomers can be used alone or in combination. Styrene is advantageously easy to handle.

The dye dispersion may contain a resin as described above. The resin contained in the dye dispersion is determined depending on the intended use and is not specifically limited. In the production of a toner by suspension granulation, a resin serving as the binder resin is blended with the dispersion. Usable specific examples of the resin include polystyrene resins, polyacrylic acid resins, polymethacrylic acid resins, polyacrylic ester resins, polymethacrylic ester resins, styrene acrylic copolymers (e.g., styrene-acrylic ester copolymers, styrene-methacrylic ester copolymers, and styrene-acrylic ester-methacrylic ester copolymers), polyester resins, polyvinyl ether resins, polyvinyl methyl ether resins, polyvinyl alcohol resins, and polyvinyl butyral resins. These resins may be used alone or in combination of two or more thereof.

The dye dispersion can be dispersed in water using an emulsifier. For example, in a case of dispersing a dye dispersion containing a resin in water, the toner can be produced by suspension granulation. Examples of the emulsifier used in this case include cationic surfactants, anionic surfactants, and nonionic surfactants. Examples of the cationic surfactant include dodecyl ammonium chloride, dodecyl ammonium bromide, dodecyl trimethyl ammonium bromide, dodecyl pyridinium chloride, dodecyl pyridinium bromide, and hexadecyl trimethyl ammonium bromide. Examples of the anionic surfactant include fatty acid soaps such as sodium stearate and sodium dodecanoate; sodium dodecylsulfate; sodium dodecylbenzenesulfate; and sodium laurylsulfate. Examples of the nonionic surfactant include dodecyl polyoxyethylene ether, hexadecyl polyoxyethylene ether, nonylphenyl polyoxyethylene ether, lauryl polyoxyethylene ether, sorbitan monooleate polyoxyethylene ether, and monodecanoyl sucrose.

### Binder Resin

The binder resin used in the present invention is not specifically limited, and, for example, thermoplastic resins can be used.

Specific examples of the binder resin include vinyl resins that are homopolymers or copolymers of polymerizable monomers. Examples of the polymerizable monomer include styrene and styrene derivatives such as styrene, p-chlorostyrene, and α-methylstyrene; acrylic esters such as methyl acrylate, ethyl acrylate, n-propyl acrylate, n-butyl acrylate, lauryl acrylate, and 2-ethylhexyl acrylate; methacrylic esters such as methyl methacrylate, ethyl methacrylate, n-propyl methacrylate, lauryl methacrylate, and 2-ethylhexyl methacrylate; vinyl nitriles such as acrylonitrile and methacrylonitrile; vinyl ethers such as vinyl ethyl ether and vinyl isobutyl ether; ketones such as vinyl methyl ketone, vinyl ethyl ketone, and vinyl isopropenyl ketone; and olefins such as ethylene, propylene, butadiene, and isoprene. Examples of the resin other than the vinyl resins include non-vinyl condensation resins such as epoxy resins, polyester resins, polyurethane resins, polyamide resins, cellulose resins, and polyether resins; and graft polymers of these non-vinyl condensation resins and vinyl monomers. These resins may be used alone or in combination of two or more thereof.

The polyester resin is synthesized from an acid-derived constituent component (dicarboxylic acid) and an alcohol-derived constituent component (diol). In the present invention, the term “acid-derived constituent component” refers to the constituent portion that has been the acid component before the synthesis of the polyester resin, and the term “alcohol-derived constituent component” refers to the constituent portion that has been the alcohol component before the synthesis of the polyester resin.

The acid-derived constituent component of the present invention is not specifically limited, and examples thereof include constituent components derived from aliphatic dicarboxylic acids, constituent components derived from dicarboxylic acids having double bonds, and constituent components derived from dicarboxylic acids having sulfonate groups. Specific examples of the constituent component include oxalic acid, malonic acid, succinic acid, glutaric acid, adipic acid, pimelic acid, suberic acid, azelaic acid, sebacic acid, 1,9-nonane dicarboxylic acid, 1,10-decane dicarboxylic acid, 1,11-undecane dicarboxylic acid, 1,12-dodecane dicarboxylic acid, 1,13-tridecane dicarboxylic acid, 1,14-tetradecane dicarboxylic acid, 1,16-hexadecane dicarboxylic acid, and 1,18-octadecane dicarboxylic acid, and lower alkyl esters and anhydrides thereof. In particular, constituent components derived from aliphatic dicarboxylic acids, such as aliphatic dicarboxylic acids having saturated carboxylic acids as the aliphatic moieties, can be used.

The alcohol-derived constituent component is not specifically limited and can be a aliphatic diol such as ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-dodecanediol, 1,12-undecanediol, 1,13-tridecanediol, 1,14-tetradecanediol, 1,18-octadecanediol, or 1,20-eicosanediol.

Any polyester resin having a molar ratio of alcohol component/acid component in a range of 45/55 to 55/45 can be used.

In polyester resins, an increase in number of the terminal groups of the molecular chain tends to increase the dependence of the charging characteristics of the toner on the environment. Accordingly, the polyester resin preferably has an acid value of 90 mg KOH/g or less and more preferably 50 mg KOH/g or less and has a hydroxyl value of 50 mg KOH/g or less and more preferably 30 mg KOH/g or less. The acid value and the hydroxyl value are each, however, 3 mg KOH/g or more in light of the frictional electrification characteristics of the toner.

In the present invention, a crosslinking agent can be used in the synthesis of the binder resin in order to increase the mechanical strength of the toner and also control the molecular weight of the toner molecule.

Any crosslinking agent can be used in the toner of the present invention. Examples of a bifunctional crosslinking agent include divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycol #200, #400, and #600, dipropylene glycol diacrylate, polypropylene glycol diacrylate, polyester-type diacrylates, and dimethacrylates corresponding to these diacrylates.

Any multifunctional crosslinking agent can be used, and examples thereof include pentaerythritol triacrylate, trimethylolethane triacrylate, trimethylolpropane triacrylate, tetramethylolmethane tetraacrylate, oligoester acrylate, and methacrylates corresponding to these acrylates, 2,2-bis(4-methacryloxyphenyl)propane, diallyl phthalate, triallyl cyanurate, triallyl isocyanurate, and triallyl trimellitate.

The amount of such a crosslinking agent is preferably 0.05 to 10 parts by mass and more preferably 0.1 to 5 parts by mass based on 100 parts by mass of the polymerizable monomer used for preparing the binder resin.

The binder resin preferably has a glass transition temperature of 45 to 80° C. and more preferably 55 to 70° C., a number-average molecular weight (Mn) of 2500 to 50000, and a weight-average molecular weight (Mw) of 10000 to 1000000.

### Wax

The wax used in the present invention is not specifically limited, and examples thereof include petroleum waxes such as paraffin wax, microcrystalline wax, and petrolatum, and derivatives thereof, montan waxes and derivatives thereof, hydrocarbon waxes by the Fischer-Tropsch process and derivatives thereof, polyolefin waxes such as polyethylene and derivatives thereof, and natural waxes such as carnauba waxes and candelilla wax and derivatives thereof. The derivatives include oxides, block copolymers with vinyl monomers, and graft-modified products. Moreover, examples of the wax include alcohols such as higher aliphatic alcohols, aliphatic acids such as stearic acid and palmitic acid and compounds thereof, acid amides, esters, ketones, hydrogenated castor oil and derivatives thereof, plant waxes, and animal waxes. These waxes can be used alone or in combination.

The amount of the wax is preferably in a range of 2.5 to 15.0 parts by mass and more preferably 3.0 to 10.0 parts by mass based on 100 parts by mass of the binder resin. The wax in an amount controlled within this range can make oilless fusing easy and is also low in influence on charging characteristics.

The wax used in the present invention preferably has a melting point of 50° C. or more and 200° C. or less and more preferably 55° C. or more and 150° C. or less. In a case of a wax having a melting point of 50° C. or more and 200° C. or less, the blocking resistance of the toner, the exudation properties of the wax in fixing, and also releasing properties in oilless fusing are also enhanced.

The melting point in the present invention refers to the endothermic peak temperature of a subject in a differential scanning calorimetry (DSC) curve measured in accordance with ASTM D3418-82. Specifically, the melting point of a wax is the endothermic peak temperature of a subject in a DSC curve obtained by measurement in the second temperature-increasing process in a temperature range of 30 to 200° C. at a rate of temperature increase of 5° C./min under ordinary temperature and ordinary humidity environment with a differential scanning calorimeter (DSC822, manufactured by Mettler Toledo International Inc.).

### Other Toner Constituent Materials

The toner of the present invention optionally contains a charge controlling agent. As a result, the frictional electrification amount can be easily optimized according to the image development system.

The charge controlling agent may be a commercially available one. In particular, a charge controlling agent showing a high charging speed and stably maintaining a certain charge amount can be used. In the production of a toner by direct polymerization, in particular, a charge controlling agent showing less inhibition of polymerization and substantially not having solubility in aqueous media can be used.

Examples of the charge controlling agent that controls a toner to negative charge include polymers or copolymers having sulfonate groups, sulfonate bases, or alkoxysulfonyl groups, salicylic acid derivatives and metal complexes thereof, monoazo metal compounds, acetylacetone metal compounds, aromatic oxycarboxylic acids, aromatic mono or polycarboxylic acids, other metal salts, anhydrides, esters, and phenol derivatives such as bisphenol, urea derivatives, metal-containing naphthoic acid compounds, boron compounds, quaternary ammonium salts, calixarenes, and resin charge controlling agents.

Examples of the charge controlling agent that controls a toner to positive charge include nigrosine and fatty acid metal salt-modified nigrosine, guanidine compounds, imidazole compounds, quaternary ammonium salts, such as tributylbenzylammonium-1-hydroxy-4-naphthosulfonate and tetrabutylammonium tetrafluoroborate, and analogs thereof, such as onium salts (e.g., phosphonium salts), and lake pigments thereof, triphenylmethane dyes and lake pigments thereof (laking agents: phosphorus tungstic acid, phosphorus molybdenic acid, phosphorus tungsten molybdenic acid, tannic acid, lauric acid, gallic acid, ferricyanide products, and ferrocyanide products), metal salts of higher fatty acids, diorganotin oxides such as dibutyltin oxide, dioctyltin oxide, and dicyclohexyltin oxide, diorganotin borates such as dibutyltin borate, dioctyltin borate, and dicyclohexyltin borate, and resin charge controlling agents. These charge controlling agents may be used or in combination of two or more thereof.

The yellow toner of the present invention may include externally added inorganic fine powder or resin particles. Examples of the inorganic fine powder include silica, titanium oxide, alumina, multiple oxides thereof, and surface-treated fine powders thereof. Examples of the resin particles include those of vinyl resins, polyester resins, and silicone resins. These inorganic fine particles and resin particles are external additives having functions of flowability aids and cleaning aids.

Methods of producing the toner particles will now be described, but the present invention is not limited to these methods.

Examples of the method of producing toner particles include pulverization, suspension polymerization, suspension granulation, emulsion polymerization, emulsion aggregation, and ester extension polymerization.

### Production of Toner Particles by Suspension Polymerization

In suspension polymerization, a polymerizable monomer composition containing a colorant, a polymerizable monomer, a wax, and a polymerization initiator is added to an aqueous medium, and toner particles are produced through a step of granulating particles of the polymerizable monomer composition in the aqueous medium and a step of polymerizing the polymerizable monomer contained in the particles of the polymerizable monomer composition.

The polymerizable monomer composition in this method of producing a toner can be prepared by mixing a dispersion (dye dispersion) of the colorant dispersed in a first polymerizable monomer with a second polymerizable monomer. That is, a colorant can be present in a better dispersion state in toner particles by sufficiently dispersing the colorant in a first polymerizable monomer and then mixing with a second polymerizable monomer together with other toner materials. The first polymerizable monomer and the second polymerizable monomer may be the same or different.

Any known polymerization initiator can be used in the suspension polymerization. Specific examples of the polymerization initiator include azo compounds, organic peroxides, inorganic peroxides, organic metal compounds, and photopolymerization initiators. More specific examples of the polymerization initiator include azo polymerization initiators such as 2,2′-azobis(isobutyronitrile), 2,2′-azobis(2-methylbutyronitrile), 2,2′-azobis(4-methoxy-2,4-dimethylvaleronitrile), 2,2′-azobis(2,4-dimethylvaleronitrile), and dimethyl-2,2′-azobis(isobutylate); organic peroxide polymerization initiators such as benzoyl peroxide, di-tert-butyl peroxide, tert-butylperoxyisopropyl monocarbonate, tert-hexylperoxybenzoate, and tert-butylperxoybenzoate; inorganic peroxide polymerization initiators such as potassium persulfate and ammonium persulfate; and redox initiators such as hydrogen peroxide-ferrous, BPO-dimethylaniline, and cerium (IV) salt-alcohol redox initiators. Examples of the photopolymerization initiator include acetophenone, benzoin methyl ether, and benzoin methyl ketal. These methods may be employed alone or in combination of two or more thereof.

The amount of the polymerization initiator is preferably in a range of 0.1 to 20 parts by mass and more preferably 0.1 to 10 parts by mass based on 100 parts by mass of the polymerizable monomer. The usable type of the polymerization initiator slightly differs depending on the method of polymerization, and one or more polymerization initiators are selected using the 10-hour half-life period temperature as reference.

The aqueous medium used in the suspension polymerization can contain a dispersion stabilizing agent. The dispersion stabilizing agent may be a known inorganic or organic one. Examples of the inorganic dispersion stabilizing agent include calcium phosphate, magnesium phosphate, aluminum phosphate, zinc phosphate, magnesium carbonate, calcium carbonate, calcium hydroxide, magnesium hydroxide, aluminum hydroxide, calcium metasilicate, calcium sulfate, barium sulfate, bentonite, silica, and alumina. Examples of the organic dispersion stabilizing agent include polyvinyl alcohol, gelatin, methyl cellulose, methyl hydroxypropyl cellulose, ethyl cellulose, sodium salts of carboxymethyl cellulose, and starch. In addition, nonionic, anionic, and cationic surfactants can be used. Specific examples of the surfactant include sodium dodecylsulfate, sodium tetradecylsulfate, sodium pentadecylsulfate, sodium octylsulfate, sodium oleate, sodium laurate, potassium stearate, and calcium oleate.

In the present invention, among dispersion stabilizing agents, acid-soluble, water-insoluble inorganic dispersion stabilizing agents can be used. In the present invention, in a case of preparing an aqueous medium with a water-insoluble inorganic dispersion stabilizing agent, the amount of the water-insoluble inorganic dispersion stabilizing agent should be in a range of 0.2 to 2.0 parts by mass based on 100 parts by mass of the polymerizable monomer, from the viewpoint of droplet stability of the polymerizable monomer composition in the aqueous medium. In the present invention, the aqueous medium can be prepared using water in a range of 300 to 3000 parts by mass based on 100 parts by mass of the polymerizable monomer composition.

In the present invention, in a case of preparing an aqueous-medium dispersion of the water-insoluble inorganic dispersion stabilizing agent, though a commercially available dispersion stabilizing agent may be directly dispersed in an aqueous medium, in order to obtain fine dispersion stabilizing agent particles having a uniform particle size, the aqueous-medium dispersion is prepared by generating microparticles of the water-insoluble inorganic dispersion stabilizing agent in water with high speed stirring. For example, in a case of using calcium phosphate as the dispersion stabilizing agent, microparticles of a dispersion stabilizing agent, i.e., calcium phosphate, can be formed by mixing of an aqueous sodium phosphate solution and an aqueous calcium chloride solution with high speed stirring.

### Production of Toner Particles by Suspension Granulation

The toner particles contained in the toner of the present invention may be particles produced by suspension granulation. Since the suspension granulation does not include any heating step, even if a wax having a low melting point, compatibility between a resin and the wax hardly occurs to inhibit a reduction in glass transition temperature of a toner caused by compatibility. Furthermore, since the suspension granulation can use a binder resin selected from various toner material options, the use of a polyester resin, which is generally advantageous in fixity, as a main component is easy. Accordingly, the suspension granulation is advantageous in production of a toner having a resin composition that is hardly applicable to suspension polymerization.

For example, toner particles can be produced by suspension granulation as follows.

A solvent composition (dye dispersion) is prepared by mixing a colorant, a binder resin, and a wax in a solvent. Particles of the solvent composition are formed by dispersing the solvent composition in a liquid medium to give a toner particle suspension. The solvent is removed by heating the resulting suspension or reducing the inner pressure of the reaction container to give toner particles.

The solvent composition may be prepared by dispersing a colorant in a first solvent and further mixing the resulting dispersion and other toner materials with a second solvent. In this process, the colorant can be present in a better dispersion state in the toner particles.

Examples of the solvent usable in the suspension granulation include hydrocarbons such as toluene, xylene, and hexane; halogen-containing hydrocarbons such as methylene chloride, chloroform, dichloroethane, trichloroethane, and carbon tetrachloride; alcohols such as methanol, ethanol, butanol, and isopropyl alcohol; polyols such as ethylene glycol, propylene glycol, diethylene glycol, and triethylene glycol; cellosolves such as methyl cellosolve and ethyl cellosolve; ketones such as acetone, methyl ethyl ketone, and methyl isobutyl ketone; ethers such as benzyl alcohol ethyl ether, benzyl alcohol isopropyl ether, and tetrahydrofuran; and esters such as methyl acetate, ethyl acetate, and butyl acetate. These solvents can be used alone or as a mixture of two or more thereof. Among these solvents, in order to easily remove the solvent in a toner particle suspension, a solvent having a low boiling point and capable of sufficiently dissolving the binder resin can be particularly used.

The amount of the solvent is preferably in a range of 50 to 5000 parts by mass and more preferably 120 to 1000 parts by mass based on 100 parts by mass of the binder resin.

The aqueous medium used in the suspension granulation can contain a dispersion stabilizing agent. Examples of the dispersion stabilizing agent are the same as those used in suspension polymerization. The amount of the dispersion stabilizing agent can be in a range of 0.01 to 20 parts by mass based on 100 parts by mass of the binder resin from the viewpoint of droplet stability of the solvent composition in the aqueous medium.

### Production of Toner Particles by Pulverization

In production of toner particles by pulverization, a colored resin powder containing a colorant and a binder resin contains a wax, a charge controlling agent, and other additives as necessary.

In pulverization, the toner can be produced using a known apparatus such as a mixer, a heat kneader, or a classifier.

A binder resin, a colorant, a wax, a charge controlling agent, and other materials as necessary are sufficiently mixed with a mixer such as a Henschel mixer or a ball mill. The mixture is then melted with a heat kneader such as a roll, a kneader, or an extruder. Furthermore, the wax was dispersed in the compatibilized resin and other components by kneading and mixing. After cooling and solidification, a toner can be prepared by pulverization and classification.

The binder resins may be used alone or in combination of two or more thereof.

In a case of mixing two or more resins, resins having different molecular weights can be used for controlling the viscoelastic properties of the toner.

### Production of Toner Particles by Emulsion Aggregation

A method of producing toner particles by emulsion aggregation will now be described.

A wax dispersion, a resin particle dispersion, a colorant particle dispersion, and a dispersion of other necessary toner components are prepared. Each dispersion contains a dispersoid and an aqueous medium. The aqueous medium is a medium of which main component is water. Specific examples of the aqueous medium include water itself, water containing a pH adjuster, and water containing an organic solvent.

Toner particles are produced through a step (aggregation step) of aggregating the particles contained in the mixture of the dispersions to form aggregate particles, a step (fusion step) of heating the aggregate particles to fuse them, a step of washing, and a step of drying.

Each dispersion of particles may contain a dispersant such as a surfactant. The colorant particles are dispersed by a known method with a rotation shearing-type homogenizer, a media-type dispersing machine such as a ball mill, a sand mill, or an attritor, or a high-pressure counter-collision-type dispersing machine.

Examples of the surfactant of the present invention include water-soluble polymers, inorganic compounds, and ionic or nonionic surfactants. Ionic surfactants advantageously have high dispersibility. In particular, anionic surfactants can be used.

The molecular weight of the surfactant is preferably 100 to 10000 and more preferably 200 to 5000, from the viewpoints of washing properties and surface-activating ability.

Specific examples of the surfactant include water-soluble polymers such as polyvinyl alcohol, methyl cellulose, carboxymethyl cellulose, and sodium polyacrylate; anionic surfactants such as sodium dodecylbenzenesulfonate, sodium octadecylsulfate, sodium oleate, sodium laurate, and potassium stearate; cationic surfactants such as laurylamine acetate and lauryltrimethyl ammonium chloride; zwitterionic surfactants such as lauryl dimethylamine oxide; nonionic surfactants such as polyoxyethylene alkyl ether, polyoxyethylene alkylphenyl ether, and polyoxyethylene alkylamine; and inorganic compounds such as tricalcium phosphate, aluminum hydroxide, calcium sulfate, calcium carbonate, and barium carbonate.

These surfactants may be used alone or in combination of two or more thereof as necessary.

### Wax Dispersion

The wax dispersion is an aqueous-medium dispersion of a wax. The wax dispersion is prepared by a known method, and the above-mentioned waxes can be used.

### Resin Particle Dispersion

The resin particle dispersion is an aqueous-medium dispersion of resin particles.

In the present invention, the term “aqueous medium” refers to a medium of which main component is water. Specific examples of the aqueous medium include water itself, water containing a pH adjuster, and water containing an organic solvent.

Examples of the resin constituting the resin particles contained in the resin particle dispersion are the same as those exemplified as the binder resin. The resin particle dispersion used in the present invention is an aqueous-medium dispersion of resin particles. The resin particle dispersion is prepared by a known method. For example, in a case of a resin particle dispersion containing particles of a resin of which constituent unit is a vinyl monomer, in particular, a styrene monomer, the resin particle dispersion can be prepared by emulsion polymerization of the monomer using, for example, a surfactant.

In a case of a resin (e.g., polyester resin) produced by another method, the resin is dispersed in water together with an ionic surfactant and a polymer electrolyte using a disperser such as a homogenizer. Subsequently, the solvent is evaporated to give a resin particle dispersion. The resin particle dispersion may be prepared by adding a surfactant to a resin and subjecting the mixture to emulsification dispersion in water using a disperser such as a homogenizer or by phase-transfer emulsification.

The resin particles in the resin particle dispersion preferably have a volume-based median diameter of 0.005 to 1.0 μm and more preferably 0.01 to 0.4 μm. The resin particles having a volume-based median diameter in this range can more easily provide a toner having an appropriate particle diameter.

The average particle diameter of the resin particles can be measured by a method such as dynamic light scattering (DLS), laser scattering, centrifugation, field-flow fractionation, or electrical detection. In the present invention, the average particle diameter of the resin particles refers to a volume-based cumulative 50% particle diameter (D50) measured at a solid content of 0.01% by mass at 20° C. by dynamic light scattering (DLS)/laser Doppler method as described below unless otherwise specified.

### Colorant Particle Dispersion

The colorant particle dispersion is an aqueous-medium dispersion of a colorant and a surfactant.

A dispersion of a compound represented by Formula (1) of the present invention is prepared. A dispersion of a mixture of compounds represented by Formula (1) may be prepared. The colorant particles can be dispersed by a known method with a rotation shearing-type homogenizer, a media-type dispersing machine such as a ball mill, a sand mill, or an attritor, or a high-pressure counter-collision-type dispersing machine.

The amount of the surfactant used is preferably 0.01 to 10 parts by mass, more preferably 0.1 to 5.0 parts by mass, and most preferably 0.5 to 3.0 parts by mass based on 100 parts by mass of the colorant from the viewpoint of easiness of removal of the surfactant in a toner. As a result, effects of reducing the amount of the surfactant remaining in the resulting toner, increasing the image density of the toner, and inhibiting occurrence of fogs can be achieved.

### Aggregation Step

The aggregate particles may be produced by any method, for example, by adding a pH adjuster, an aggregating agent, and a stabilizer to the above-mentioned mixture solution and mixing them at an appropriate temperature with appropriately applying a mechanical power (stirring).

The pH adjuster is not specifically limited, and examples thereof include alkalis such as ammonia and sodium hydroxide and acids such as nitric acid and citric acid.

The aggregating agent is not specifically limited, and examples thereof include inorganic metal salts such as sodium chloride, magnesium carbonate, magnesium chloride, magnesium nitrate, magnesium sulfate, calcium chloride, and aluminum sulfate; and multivalent metal complexes.

Typical examples of the stabilizer include surfactants.

The surfactant is not specifically limited, and examples thereof include water-soluble polymers such as polyvinyl alcohol, methyl cellulose, carboxymethyl cellulose, and sodium polyacrylate; anionic surfactants such as sodium dodecylbenzenesulfonate, sodium octadecylsulfate, sodium oleate, sodium laurate, and potassium stearate; cationic surfactants such as laurylamine acetate and lauryltrimethyl ammonium chloride; zwitterionic surfactants such as lauryl dimethylamine oxide; nonionic surfactants such as polyoxyethylene alkyl ether, polyoxyethylene alkylphenyl ether, and polyoxyethylene alkylamine; and inorganic compounds such as tricalcium phosphate, aluminum hydroxide, calcium sulfate, calcium carbonate, and barium carbonate. These surfactants may be used alone or in combination of two or more thereof as necessary.

The average particle diameter of the aggregate particles formed herein is not specifically limited and is usually adjusted to be the same as that of the toner particles to be prepared. The adjustment can be readily achieved by appropriately controlling the temperature during the addition and mixing of the aggregating agent and other additives and the conditions in the stirring and mixing. Furthermore, in order to reduce the fusion of toner particles, the pH adjuster and the surfactant may be appropriately added.

### Fusion Step

In the fusion step, toner particles are formed by heating the aggregate particles for fusion thereof.

The heating is performed at any temperature between the glass transition temperature (Tg) of the resin contained in the aggregate particles and the decomposition temperature of the resin. The progress of aggregation is terminated by addition of a surfactant or adjustment of the pH with stirring as in the aggregation step, and the aggregate particles are fused and united by heating to a temperature higher than the glass transition temperature of the resin of the resin particles.

The heating is carried out for a period of time sufficient for fusion and is specifically from about 10 min to 10 hours.

Furthermore, a step (attachment step) of forming a core shell structure by mixing a dispersion of microparticles with the aggregate particles to attach the microparticles to the aggregate particles may be performed before or after the fusion step.

### Washing Step

The toner particles prepared after the fusion step are washed, filtered, and dried under appropriate conditions. In order to ensure sufficient charging characteristics and reliability as a toner, the toner particles are sufficiently washed.

The washing may be performed by any method. For example, toner particles can be washed by filtering a suspension containing the toner particles, stirring the resulting filter residue in distilled water, and further performing filtration. From the viewpoint of the electrification of the toner, the washing is repeated until the conductance of the filtrate is reduced to 150 μS/cm or less. Washing until the conductance of the filtrate is reduced to 150 μS/cm or less inhibits a reduction in charging characteristics of the toner, resulting in inhibition of occurrence of fogs and improvement of image density.

### Drying Step

Drying can be performed by a known method such as vibrating fluidized drying, spray drying, lyophilization, or flash jetting. The water fraction of the toner particles after drying is preferably 1.5% by mass or less and more preferably 1.0% by mass or less.

The yellow toner of the present invention preferably has a weight-average particle diameter (D4) of 4.0 to 9.0 μm and more preferably 4.9 to 7.5 μm. A yellow toner having a weight-average particle diameter (D4) within this range has enhanced electrification stability and further inhibits occurrence of image fogs and development lines even in continuous image development operation of a large number of sheets (duration operation). The reproducibility of a halftone portion is also improved.

In the yellow toner of the present invention, the ratio of the weight-average particle diameter (D4) to the number-average particle diameter (D1) (hereinafter, also referred to as weight-average particle diameter (D4)/number-average particle diameter (D1) or D4/D1) is preferably 1.35 or less and more preferably 1.30 or less. A yellow toner satisfying this relationship inhibits occurrence of fogs and has improved transferability and can also make the line width more uniform.

The weight-average particle diameter (D4) and the number-average particle diameter (D1) of the yellow toner of the present invention are adjusted by different methods depending on the method of producing the toner particles. For example, in a case of suspension polymerization, these particle diameters can be adjusted by controlling the dispersant concentration used in preparation of the aqueous medium, the reaction stirring rate, or the reaction stirring time.

The yellow toner of the present invention preferably has an average circularity of 0.930 or more and 0.995 or less and more preferably 0.960 or more and 0.990 or less when measured with a flow particle image analyzer. Such a toner has remarkably improved transferability.

The toner of the present invention can also be used in a developer (hereinafter, referred to as liquid developer) that is used in liquid development.

### Method of Producing Liquid Developer

A method of producing a liquid developer will now be described.

The liquid developer is produced by dispersing or dissolving a colored resin powder containing a compound represented by Formula (1) and auxiliary agents such as a charge controlling agent and a wax as necessary in a carrier liquid having an electric insulation property. Alternatively, the developer may be prepared by two stages of preparation of a concentrated toner and dilution with a carrier liquid having an electric insulation property.

Any dispersant can be used, and a rotation shearing-type homogenizer, a media-type dispersing machine such as a ball mill, a sand mill, or an attritor, or a high-pressure counter-collision-type dispersing machine can be used.

The colored resin powder may further contain one or more colorants such as known pigments and dyes.

Examples of the wax and the colorant are the same as those described above.

Any charge controlling agent that is used in liquid developers for static charge development can be used, and examples thereof include cobalt naphthenate, copper naphthenate, copper oleate, cobalt oleate, zirconium octoate, cobalt octoate, sodium dodecylbenzenesulfonate, calcium dodecylbenzenesulfonate, soybean lecithin, and aluminum octoate.

The carrier liquid having an electric insulation property used in the present invention is not specifically limited, and an organic solvent having a high electric resistance of 10⁹ Ω·cm or more and a low dielectric constant of 3 or less can be used.

Specific examples of the organic solvent include aliphatic hydrocarbon solvents such as hexane, pentane, octane, nonane, decane, undecane, and dodecane; and solvents having a boiling point in the range of 68 to 250° C., such as Isopar H, G, K, L, and M (manufactured by Exxon Chemical Co., Ltd.) and Linealene Dimer A-20 and A-20H (manufactured by Idemitsu Kosan Co., Ltd.). These may be used alone or in combination of two or more thereof within the range that does not increase the viscosity of the system.

### EXAMPLES

The present invention will now be described in more detail by examples and comparative examples, but is not limited to these examples. Note that in the following description, “part(s)” and “%” are based on mass unless otherwise specified. Reaction products were identified by a plurality of analytical methods using the apparatuses described below. That is, analytical apparatuses used were ECA-400 (manufactured by JEOL Ltd.) for ¹H nuclear magnetic resonance spectrometry (NMR) and autoflex (manufactured by Bruker Daltonics K.K.) for matrix-assisted laser desorption-ionization mass spectrometry (MALDI-MS). The detection by MALDI-MS was in the negative ion mode.

### Synthesis Example 1

### Production of Compound (1)

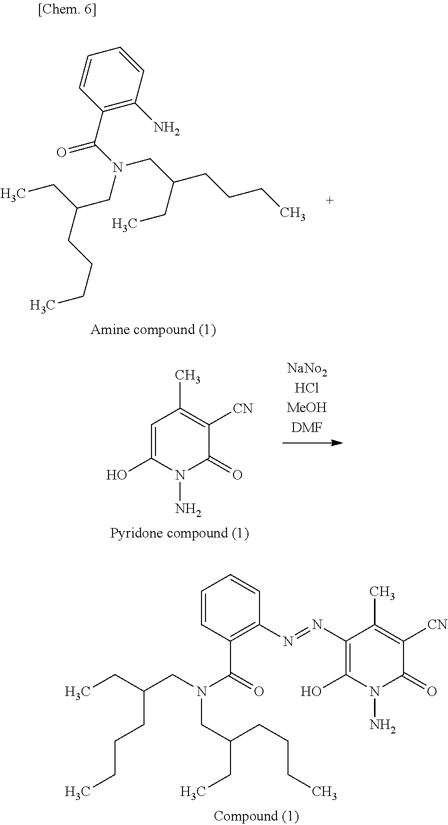

A solution of 3.61 g of an amine compound (1) in 20 mL of methanol (MeOH) was cooled to 5° C., and 2.65 mL of 35% hydrochloric acid was dropwise added thereto. To this solution was dropwise added a solution of 0.76 g of sodium nitrite in 3 mL of water to give diazotization solution A. Separately, a solution of 1.65 g of pyridone compound (1) in 8 mL of N,N-dimethylformamide (DMF) was cooled to 5° C., and diazotization solution A was dropwise added thereto slowly such that the temperature was maintained at 5° C. or less, followed by stirring at 0 to 5° C. for 3 hours. After completion of the reaction, the reaction solution was neutralized to a pH of 6 by dropwise addition of an aqueous sodium carbonate solution. The precipitated solid was collected by filtration and was further washed with water. The resulting solid was purified by column chromatography (developing solvent: heptane/ethyl acetate) and was further recrystallized from a heptane solution to yield 1.4 g of Compound (1).

### Results of Analysis of Compound (1)

[1] ¹H-NMR (400 MHz, CDCl₃, room temperature): δ (ppm)=15.12 (1H, s), 7.88 (1H, d, J=8.39 Hz), 7.54-7.50 (1H, m), 7.33-7.29 (2H, m), 5.31 (2H, s), 3.72-3.32 (2H, br), 3.26 (2H, d, J=6.48 Hz), 2.64 (3H, s), 1.83 (1H, s), 1.51-1.30 (9H, m), 1.12-0.75 (14H, m), 0.74 (3H, s), 0.62 (3H, s).

[2] Mass spectrometry by MALDI-TOF-MS: m/z=535.617 (M-H)⁻

### Synthesis Example 2

### Production of Compound (4)

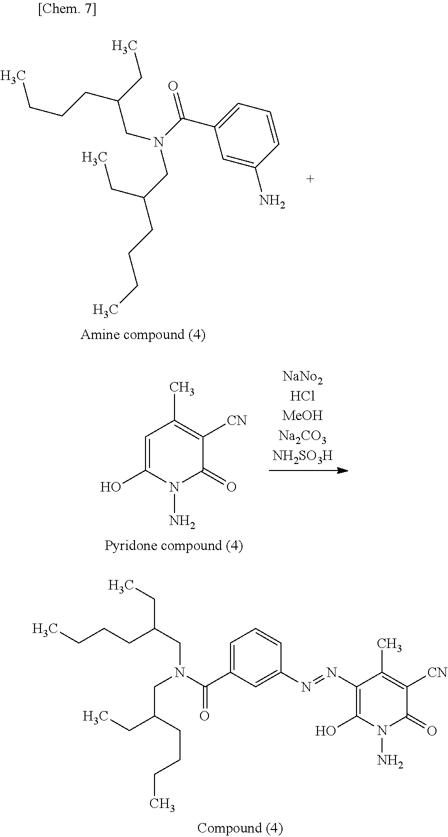 [SMILES: CCCCC(CC)CN(CC(CC)CCCC)C(=O)c1cccc(N)c1 ; Cc1cc(O)n(N)c(=O)c1C#N ; CCCCC(CC)CN(CC(CC)CCCC)C(=O)c1cccc(/N=N/c2c(C)c(C#N)c(=O)n(N)c2O)c1]

A solution of 3.61 g of an amine compound (4) in 20 mL of methanol (MeOH) was cooled to 5° C., and 2.65 mL of 35% hydrochloric acid was dropwise added thereto. To this solution was dropwise added a solution of 0.76 g of sodium nitrite in 3 mL of water, followed by stirring for 1 hour. Subsequently, 0.117 g of amidosulfuric acid was added to the reaction solution to decompose excess sodium nitrite to give diazotization solution B. Separately, a solution of 1.65 g of pyridone compound (4) in 8 mL of N,N-dimethylformamide (DMF) was cooled to 5° C., and diazotization solution B was dropwise added thereto slowly such that the temperature was maintained at 5° C. or less, followed by stirring at 0 to 5° C. for 3 hours. After completion of the reaction, the reaction solution was neutralized to a pH of 6 by dropwise addition of an aqueous sodium carbonate solution, followed by extraction with chloroform. The chloroform layer was concentrated, and the resulting solid was purified by column chromatography (developing solvent: heptane/chloroform) and was further recrystallized from a heptane/chloroform solution to yield 2.5 g of Compound (4).

### Results of Analysis of Compound (4)

[1] ¹H-NMR (400 MHz, CDCl₃, room temperature): δ (ppm)=14.99 (1H, s), 7.52-7.48 (3H, m), 7.29 (1H, s), 5.27 (2H, s), 3.46 (2H, d, J=5.72 Hz), 3.17 (2H, d, J=6.87 Hz), 2.63 (3H, s), 1.84-1.75 (1H, br), 1.59-1.49 (1H, br), 1.47-1.28 (9H, s), 1.24-1.16 (3H, br), 1.13-1.02 (4H, br), 0.98-0.92 (6H, m), 0.83 (3H, t, J=7.25 Hz), 0.72 (3H, t, J=7.44 Hz).

[2] Mass spectrometry by MALDI-TOF-MS: m/z=535.457 (M-H)⁻

### Synthesis Example 3

### Production of Compound (8)

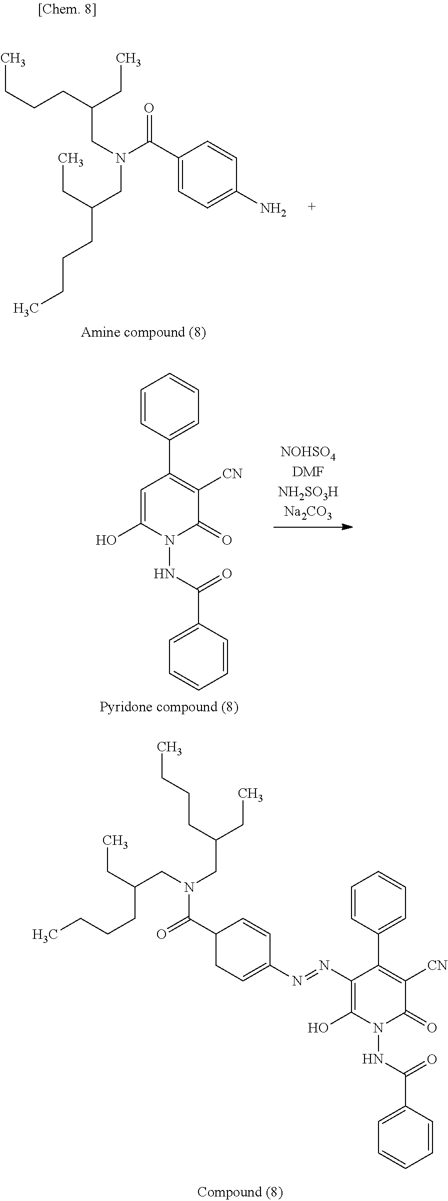 [SMILES: CCCCC(CC)CN(CC(CC)CCCC)C(=O)c1ccc(N)cc1 ; N#Cc1c(-c2ccccc2)cc(O)n(NC(=O)c2ccccc2)c1=O ; CCCCC(CC)CN(CC(CC)CCCC)C(=O)C1C=CC(/N=N/c2c(-c3ccccc3)c(C#N)c(=O)n(NC(=O)c3ccccc3)c2O)=CC1]

A solution of 3.61 g of an amine compound (8) in 20 mL of N,N-dimethylformamide (DMF) was cooled to 5° C., and 20 mL of a 40% nitrosylsulfuric acid solution in N,N-dimethylformamide was dropwise slowly added thereto. To this solution was dropwise added a solution of 0.76 g of sodium nitrite in 3 mL of water, followed by stirring for 1 hour. Subsequently, 0.117 g of amidosulfuric acid was added to the reaction solution to decompose excess nitrosylsulfuric acid to give diazotization solution C. Separately, a solution of 3.31 g of pyridone compound (8) in 8 mL of N,N-dimethylformamide (DMF) was cooled to 5° C., and diazotization solution C was dropwise added thereto slowly such that the temperature was maintained at 5° C. or less, followed by stirring at 0 to 5° C. for 3 hours. After completion of the reaction, the reaction solution was extracted with chloroform. The chloroform layer was concentrated, and the resulting solid was purified by column chromatography (developing solvent: heptane/chloroform) and was further recrystallized from a heptane/chloroform solution to yield 3 g of Compound (8).

### Results of Analysis of Compound (8)

[1] ¹H-NMR (400 MHz, CDCl₃, room temperature): δ (ppm)=14.58 (1H, s), 9.71 (1H, s), 8.01 (2H, d, J=7.63 Hz), 7.60-7.53 (4H, m), 7.49-7.42 (4H, m), 7.32 (2H, d, J=8.39 Hz), 7.09 (2H, d, J=8.39 Hz), 3.53-3.30 (2H, m), 3.11 (2H, d, J=6.48 Hz), 1.79 (1H, s), 1.61-0.79 (26H, m), 0.68 (3H, s).

[2] Mass spectrometry by MALDI-TOF-MS: m/z=701.476 (M-H)⁻

### Synthesis Example 4

### Production of Compound (13)

Compound (13) was prepared as in Synthesis Example 1 except that amine compound (13) and pyridone compound (13) were respectively used in place of amine compound (1) and pyridone compound (1) in Synthesis Example 1.

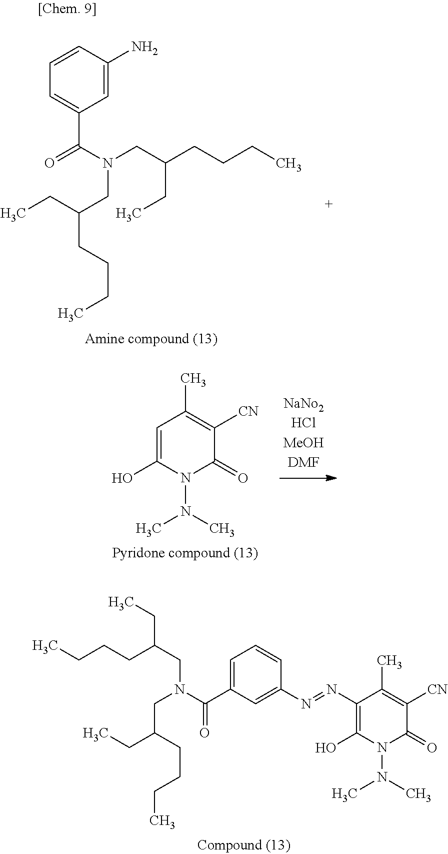

### Results of Analysis of Compound (13)

[1] ¹H-NMR (CDCl₃) δ (ppm): 14.99 (1H, s), 7.51-7.43 (3H, m), 7.25 (1H, s), 3.45 (2H, s), 3.17 (2H, d, J=6.87 Hz), 3.00 (6H, s), 2.59 (3H, s), 1.79-1.71 (1H, br), 1.61-1.50 (2H, br), 1.38-1.26 (8H, br), 1.24-1.18 (3H, br), 1.15-1.01 (4H, br), 0.98-0.88 (6H, m), 0.83 (3H, t, J=7.06 Hz), 0.71 (3H, t, J=7.25 Hz).

[2] Mass spectrometry: m/z=563.495 (M-H)⁻

### Synthesis Example 5

### Production of Compound (15)

Compound (15) was prepared as in Synthesis Example 1 except that amine compound (15) and pyridone compound (15) were respectively used in place of amine compound (1) and pyridone compound (1) in Synthesis Example 1.

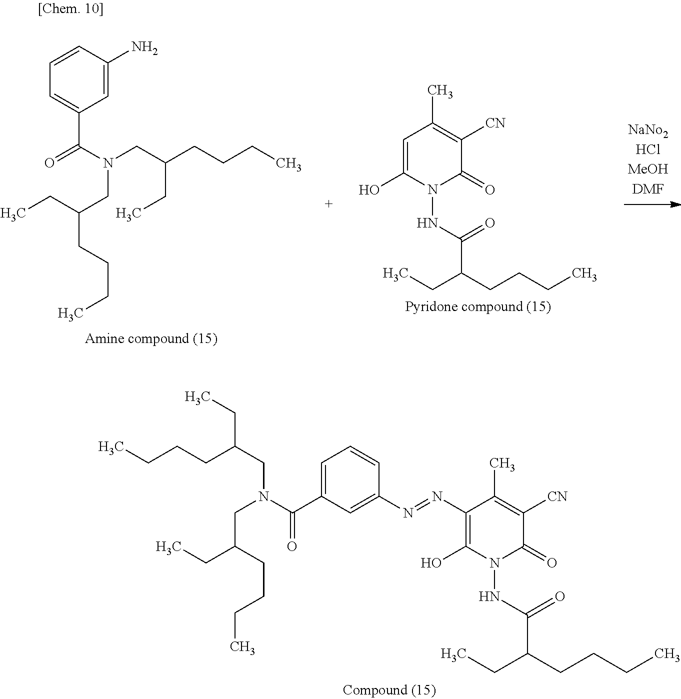 [SMILES: CCCCC(CC)CN(CC(CC)CCCC)C(=O)c1cccc(N)c1 ; CCCCC(CC)C(=O)Nn1c(O)cc(C)c(C#N)c1=O ; CCCCC(CC)CN(CC(CC)CCCC)C(=O)c1cccc(/N=N/c2c(C)c(C#N)c(=O)n(NC(=O)C(CC)CCCC)c2O)c1]

### Results of Analysis of Compound (15)

[1] ¹H-NMR (400 MHz, CDCl₃, room temperature): δ (ppm)=14.48 (1H, s), 9.92-9.72 (1H, br), 7.48 (1H, dd, J=7.63 Hz, J=7.65 Hz), 7.35 (1H, d, J=8.39 Hz), 7.23 (1H, s), 7.17 (1H, d, J=7.25 Hz), 3.62-3.31 (2H, m), 3.10 (2H, s), 2.55 (3H, s), 2.48-2.41 (1H, br), 1.88-1.82 (1H, br), 1.75-1.65 (2H, br), 1.54-1.25 (17H, m), 1.23-1.11 (3H, m), 1.09-0.94 (15H, m), 0.81 (3H, t, J=7.06 Hz), 0.68 (3H, d, J=9.16 Hz).

[2] Mass spectrometry by MALDI-TOF-MS: m/z=661.535 (M-H)⁻

### Synthesis Example 6

### Production of Compound (23)

Compound (23) was prepared as in Synthesis Example 1 except that amine compound (23) and pyridone compound (23) were respectively used in place of amine compound (1) and pyridone compound (1) in Synthesis Example 1.

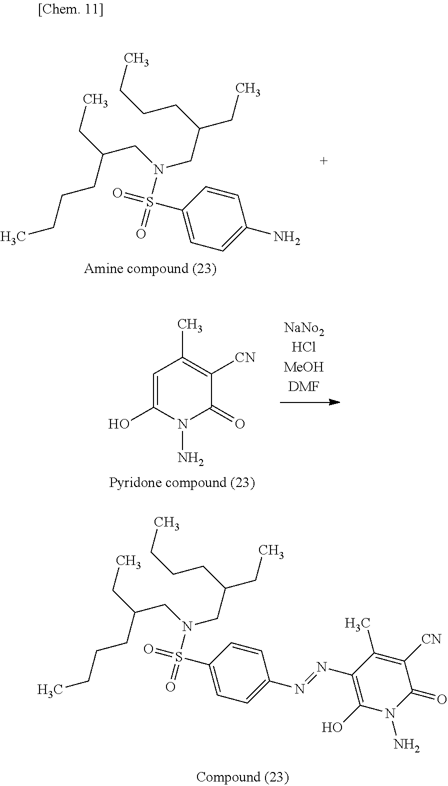 [SMILES: CCCCC(CC)CN(CC(CC)CCCC)S(=O)(=O)c1ccc(N)cc1 ; Cc1cc(O)n(N)c(=O)c1C#N ; CCCCC(CC)CN(CC(CC)CCCC)S(=O)(=O)c1ccc(/N=N/c2c(C)c(C#N)c(=O)n(N)c2O)cc1]

### Results of Analysis of Compound (23)

[1] ¹H-NMR (400 MHz, CDCl₃, room temperature): δ (ppm)=14.90 (1H, s), 7.88 (2H, d, J=8.39 Hz), 7.54 (2H, d, J=8.39 Hz), 5.25 (2H, s), 3.04-2.86 (4H, m), 2.68 (3H, s), 1.63-1.51 (2H, br), 1.38-1.25 (16H, m), 0.94-0.78 (12H, m).

[2] Mass spectrometry by MALDI-TOF-MS: m/z=571.417 (M-H)⁻

### Production of Yellow Toner

Yellow toners of the present invention and Comparative yellow toners were produced as follows.

### Synthesis Example 7

### Production of Compound (28)

Compound (28) was prepared as in Synthesis Example 1 except that amine compound (28) and pyridone compound (28) were respectively used in place of amine compound (1) and pyridone compound (1) in Synthesis Example 1.

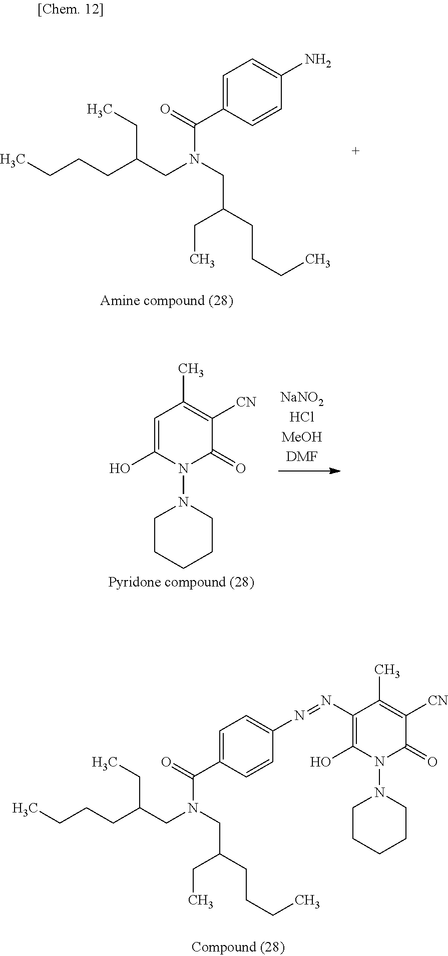

### Results of Analysis of Compound (28)

[1] ¹H-NMR (CDCl₃) δ (ppm): 14.98 (1H, s), 7.47 (4H, s), 3.56-3.49 (2H, m), 3.48-3.29 (2H, m), 3.28-3.20 (2H, m), 3.19-2.98 (2H, m), 2.60 (3H, s), 1.84-1.74 (4H, m), 1.73-1.65 (3H, m), 1.64-1.49 (1H, m), 1.48-1.25 (9H, m), 1.24-1.12 (3H, m), 1.11-1.01 (4H, m), 1.00-0.78 (9H, m), 0.75-0.66 (3H, m).

[2] Mass spectrometry by MALDI-TOF-MS: m/z=603.415 (M-H)⁻

### Synthesis Example 8

### Production of Compound (29)

Compound (29) was prepared as in Synthesis Example 1 except that amine compound (29) and pyridone compound (29) were respectively used in place of amine compound (1) and pyridone compound (1) in Synthesis Example 1.

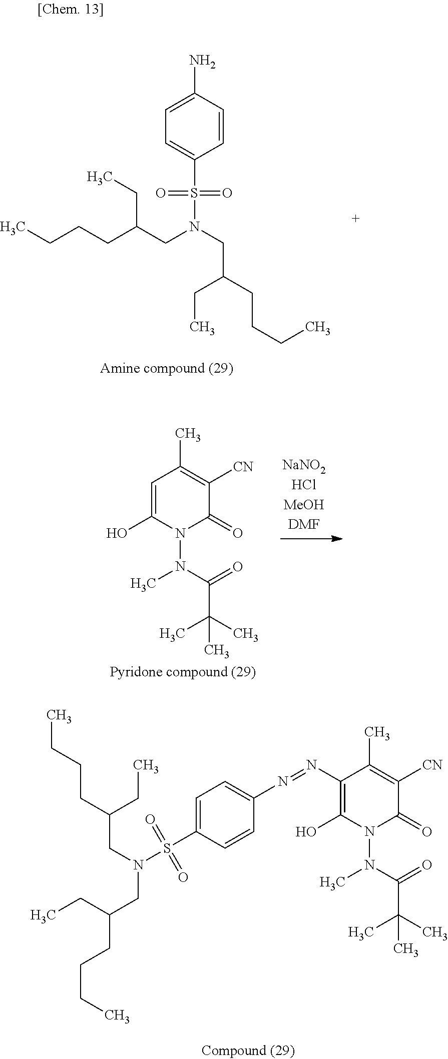

### Results of Analysis of Compound (29)

[1] ¹H-NMR (CDCl₃) δ (ppm): 14.62 (1H, s), 7.88 (2H, d, J=8.77 Hz), 7.54 (2H, d, J=8.77 Hz), 3.52 (3H, s), 3.04-2.92 (4H, m), 2.66 (3H, s), 1.41 (9H, s), 1.31-1.06 (17H, m), 0.91-0.81 (13H, m).

[2] Mass spectrometry by MALDI-TOF-MS: m/z=669.776 (M-H)⁻

### Synthesis Example 9

### Production of Compound (30)

Compound (30) was prepared as in Synthesis Example 1 except that amine compound (30) and pyridone compound (30) were respectively used in place of amine compound (1) and pyridone compound (1) in Synthesis Example 1.

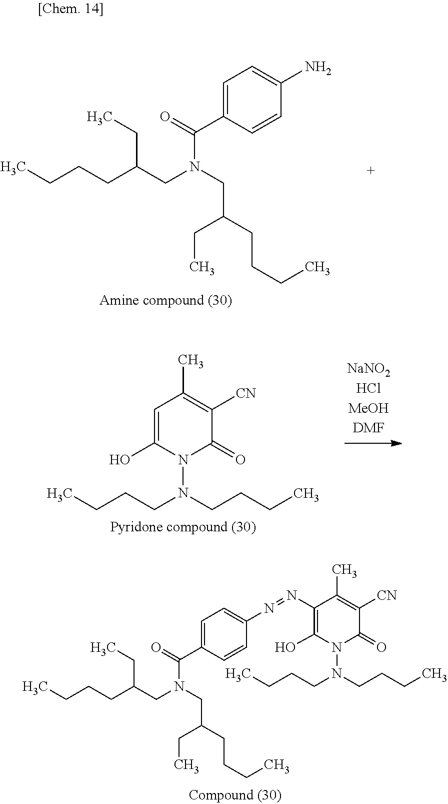

### Results of Analysis of Compound (30)

[1] ¹H-NMR (CDCl₃) δ (ppm): 15.02 (1H, s), 7.49 (4H, d, J=2.54 Hz), 3.50-3.38 (2H, m), 3.37-3.26 (2H, m), 3.20-3.09 (4H, m), 2.63 (3H, s), 1.64 (2H, s), 1.60-1.47 (1H, br), 1.45-1.02 (23H, m), 0.99-0.76 (15H, m), 0.74-0.61 (3H, m).

[2] Mass spectrometry by MALDI-TOF-MS: m/z=647.401 (M-H)⁻

### Example 1

A mixture of 5 parts by mass of Compound (1) and 120 parts by mass of styrene was melted with an attritor (manufactured by Mitsui Mining Co., Ltd.) for 3 hours to prepare dye dispersion (1) of the present invention.

A 2-L four-necked flask equipped with a high-speed stirring device, T.K. homomixer (manufactured by Primix Corp.) was charged with 710 parts of ion exchange water and 450 parts of a 0.1 mol/L trisodium phosphate aqueous solution, followed by heating to 60° C. with stirring at 12000 rpm. To this mixture was gradually added 68 parts of a 1.0 mol/L calcium chloride aqueous solution to prepare an aqueous medium containing water-insoluble fine calcium phosphate serving as a dispersion stabilizing agent.

The following materials:

dye dispersion (1): 133.2 parts by mass,

styrene: 46.0 parts by mass,

n-butyl acrylate: 34.0 parts by mass,

aluminum salicylate compound (Bontron E-88, manufactured by Orient Chemical Industries, Ltd.): 2.0 parts by mass,

polar resin (polycondensate of propylene oxide-modified bisphenol A and isophthalic acid, Tg: 65° C., Mw: 10000, Mn: 6000): 10.0 parts by mass, ester wax (maximum endothermic peak temperature measured by DSC: 70° C., Mn: 704): 25.0 parts by mass, and divinylbenzene: 0.10 parts by mass were heated to 60° C. and were uniformly mixed and dispersed with a T.K. homomixer at 5000 rpm. In this mixture was dissolved 10 parts by mass of 2,2′-azobis(2,4-dimethylvaleronitrile) as a polymerization initiator to prepare a polymerizable monomer composition. This polymerizable monomer composition was put in the aqueous medium prepared above, followed by granulation at 12000 rpm for 15 minutes. Subsequently, the high-speed stirring device was changed to a propeller stirring blade, and polymerization was continued at a solution temperature of 60° C. for 5 hours and then at a solution temperature of 80° C. for 8 hours. After completion of the polymerization, the residual monomer was distilled away at 80° C. under reduced pressure, and the solution temperature was then reduced to 30° C. to give a polymer microparticle dispersion.

The polymer microparticle dispersion was transferred to a washing container, and diluted hydrochloric acid was added to the dispersion with stirring to adjust the pH to 1.5. The dispersion was further stirred for 2 hours, and then polymer microparticles were collected through solid-liquid separation by filtration. Redispersion of the polymer microparticles into water and solid-liquid separation were repeated until phosphoric acid and calcium compounds including calcium phosphate were thoroughly removed. Polymer microparticles finally prepared by solid-liquid separation were sufficiently dried with a dryer to yield yellow toner particles (1).

Yellow toner (1) of the present invention was prepared by mixing 100 parts by mass of the resulting yellow toner particles (1) with 1.00 part by mass of a hydrophobic silica fine powder (primary particle number-average particle diameter: 7 nm) surface-treated with hexamethyldisilazane, 0.15 parts by mass of a rutile-type titanium oxide fine powder (primary particle number-average particle diameter: 45 nm), and 0.50 parts by mass of a rutile-type titanium oxide fine powder (primary particle number-average particle diameter: 200 nm) by dry blending with a Henschel mixer (manufactured by Nippon Coke & Engineering Co., Ltd.) for 5 minutes.

### Examples 2 to 3

Yellow toners (2) and (3) of the present invention were prepared as in Example 1 except that 6 parts by mass of Compound (4) and 7 parts by mass of Compound (13) were respectively used in place of 5 parts by mass of Compound (1) in Example 1.

### Comparative Example 1

Comparative yellow toner (Comparative 1) was prepared as in Example 1 except that Comparative Compound (1) was used in place of Compound (1) in Example 1.

The structure of Comparative Compound (1) is shown below.

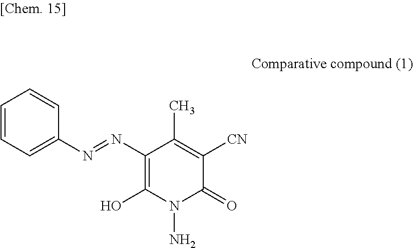 [SMILES: Cc1c(/N=N/c2ccccc2)c(O)n(N)c(=O)c1C#N]

### Example 4

A solution was prepared by mixing 82.6 parts by mass of styrene, 9.2 parts by mass of n-butyl acrylate, 1.3 parts by mass of acrylic acid, 0.4 parts by mass of hexanediol acrylate, and 3.2 parts by mass of n-lauryl mercaptan. To this solution was added an aqueous solution of 1.5 parts by mass of Neogen RK (manufactured by Daiichi Kogyo Seiyaku Co., Ltd.) in 150 parts by mass of ion exchange water, followed by dispersing treatment. An aqueous solution of 0.15 parts by mass of potassium persulfate in 10 parts by mass of ion exchange water was added to the dispersion with slowly stirring for 10 minutes. After nitrogen purge, emulsion polymerization was performed at 70° C. for 6 hours. After completion of the polymerization, the reaction solution was cooled to room temperature, ion exchange water was added to the solution to give a resin particle dispersion having a solid concentration of 12.5% by mass and a volume-based median diameter of 0.2 μm.

A wax dispersion was prepared by mixing 100 parts by mass of ester wax (maximum endothermic peak temperature measured by DSC: 70° C., Mn: 704) and 15 parts by mass of Neogen RK with 385 parts by mass of ion exchange water and performing dispersing treatment with a wet-type jet mill JN100 (manufactured by Jokoh Co., Ltd.) for about 1 hour. The concentration of the wax dispersion was 20% by mass.

A Compound (1) dispersion was prepared by mixing 100 parts by mass of Compound (1) and 15 parts by mass of Neogen RK with 885 parts by mass of ion exchange water and performing dispersing treatment with a wet-type jet mill JN100 (manufactured by Jokoh Co., Ltd.) for about 1 hour.

The volume-based median diameter of the colorant particles in the Compound (1) dispersion was 0.2 μm, and the concentration of the Compound (1) dispersion was 10% by mass.

A mixture of 160 parts by mass of the resin particle dispersion, 10 parts by mass of the wax dispersion, 10 parts by mass of the Compound (1) dispersion, and 0.2 parts by mass of magnesium sulfate was subjected to dispersing treatment with a homogenizer (Ultra Turrax T50, manufactured by IKA Japan K.K.). The dispersion was heated to 65° C. with stirring and was further stirred at 65° C. for 1 hour. It was confirmed by observation with an optical microscope that aggregate particles having an average particle diameter of about 6.0 μm were formed. To this dispersion was added 2.2 parts by mass of Neogen RK (manufactured by Daiichi Kogyo Seiyaku Co., Ltd.). The mixture was heated to 80° C. and was then stirred for 120 minutes to give fused spherical toner particles. After cooling, the solid content was collected by filtration and was washed in 720 parts by mass of ion exchange water by stirring for 60 minutes. The solution containing the toner particles was filtered, and the washing process was repeated until the conductance of the filtrate was reduced to 150 μS/cm or less, followed by drying with a vacuum dryer to yield toner particles (1).

Yellow toner (4) was prepared by mixing 100 parts by mass of the toner particles (1) with 1.8 parts by mass of a hydrophobized silica fine powder having a specific surface area of 200 m²/g, measured by a BET method, by dry blending with a Henschel mixer (manufactured by Mitsui Mining Co., Ltd.).

### Example 5

Yellow toner (5) of the present invention was prepared as in Example 4 except that 60 parts by mass of Compound (15) was used in place of 100 parts by mass of Compound (1) in Example 4.

### Comparative Example 2

Comparative yellow toner (Comparative 2) was prepared as in Example 4 except that Comparative Compound (2) was used in place of Compound (1) in Example 4.

The structure of Comparative Compound (2) is shown below.

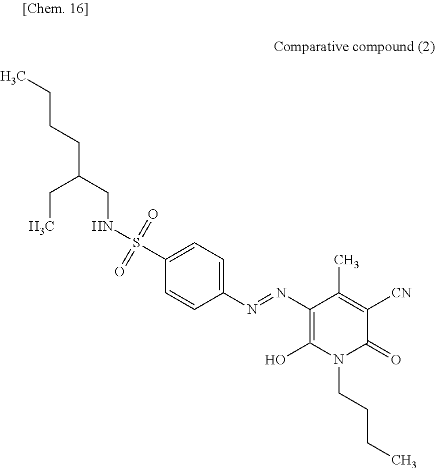 [SMILES: CCCCC(CC)CNS(=O)(=O)c1ccc(/N=N/c2c(C)c(C#N)c(=O)n(CCCC)c2O)cc1]

### Example 6

A binder resin (polyester resin) (Tg: 55° C., acid value: 20 mg KOH/g, hydroxyl value: 16 mg KOH/g, molecular weight: Mp=4500, Mn=2300, Mw=38000): 100 parts by mass, Compound (8): 5 parts by mass, aluminum 1,4-di-t-butylsalicylate compound: 0.5 parts by mass, and paraffin wax (maximum endothermic peak temperature: 78° C.): 5 parts by mass were sufficiently mixed with a Henschel mixer (model FM-75J, manufactured by Mitsui Mining Co., Ltd.). The mixture was kneaded with a biaxial kneader (model PCM-45, manufactured by Ikegai Corp.) heated to 130° C. at a feeding rate of 60 kg/hr (the temperature of kneaded product when it was discharged was about 150° C.). The kneaded product was cooled, was roughly pulverized with a hammer mill, and was then finely pulverized with a mechanical pulverizer (T-250, manufactured by Freund-Turbo Corporation) at a feeding rate of 20 kg/hr.

The finely pulverized toner product was further classified with a multi-division classifier utilizing the Coanda effect to give toner particles.

Yellow toner (6) was prepared by mixing 100 parts by mass of the resulting toner particles with 1.8 parts by mass of a hydrophobized silica fine powder having a specific surface area of 200 m²/g, measured by a BET method, by dry blending with a Henschel mixer (manufactured by Mitsui Mining Co., Ltd.).

### Example 7

Yellow toner (7) of the present invention was prepared as in Example 6 except that 5 parts by mass of Compound (23) was used in place of 5 parts by mass of Compound (8) in Example 6.

### Comparative Example 3

Comparative yellow toner (Comparative 3) was prepared as in Example 6 except that Comparative Compound (1) was used in place of 5 parts by mass of Compound (8) in Example 6.

### Example 8

Yellow toner (8) of the present invention was prepared as in Example 1 except that 4 parts by mass of C.I. Pigment Yellow 185 (manufactured by BASF, trade name: “PALIOTOL Yellow D1155”) and 3 parts by mass of Compound (1) were used in place of 5 parts by mass of Compound (1) in Example 1.

### Example 9

A resin particle dispersion having a solid concentration of 12.5% by mass and a volume-based median diameter of 0.2 μm and a wax dispersion having a concentration of 20% by mass were prepared as in Example 4.

A C.I. Pigment Yellow 180 dispersion was prepared by mixing 100 parts by mass of C.I. Pigment Yellow 180 (manufactured by DIC Corporation, trade name: “SYMULER Fast Yellow BY2000GT”) and 15 parts by mass of Neogen RK with 885 parts by mass of ion exchange water and performing dispersing treatment with a wet-type jet mill JN100 (manufactured by Jokoh Co., Ltd.) for about 1 hour.

The volume-based median diameter of the colorant particles in the C.I. Pigment Yellow 180 dispersion was 0.2 μm, and the concentration of the C.I. Pigment Yellow 180 dispersion was 10% by mass.

A Compound (15) dispersion was prepared by mixing 100 parts by mass of Compound (15) and 15 parts by mass of Neogen RK with 885 parts by mass of ion exchange water and performing dispersing treatment with a wet-type jet mill JN100 (manufactured by Jokoh Co., Ltd.) for about 1 hour.

The volume-based median diameter of the colorant particles in the Compound (15) dispersion was 0.2 μm, and the concentration of the Compound (15) dispersion was 10% by mass.

A mixture of 160 parts by mass of the resin particle dispersion, 10 parts by mass of the wax dispersion, 3 parts by mass of the C.I. Pigment Yellow 180 dispersion, 4 parts by mass of the Compound (15) dispersion, and 0.2 parts by mass of magnesium sulfate was subjected to dispersing treatment with a homogenizer (Ultra Turrax T50, manufactured by IKA Japan K.K.). The dispersion was heated to 65° C. with stirring and was further stirred at 65° C. for 1 hour. It was confirmed by observation with an optical microscope that aggregate particles having an average particle diameter of about 6.0 μm were formed. To this dispersion was added 2.2 parts by mass of Neogen RK (manufactured by Daiichi Kogyo Seiyaku Co., Ltd.). The mixture was heated to 80° C. and was then stirred for 120 minutes to give fused spherical toner particles. After cooling, the solid content was collected by filtration and was washed in 720 parts by mass of ion exchange water by stirring for 60 minutes. The solution containing the toner particles was filtered, and the washing process was repeated until the conductance of the filtrate was reduced to 150 μS/cm or less, followed by drying with a vacuum dryer to yield toner particles.

Yellow toner (9) was prepared by mixing 100 parts by mass of the resulting toner particles with 1.8 parts by mass of a hydrophobized silica fine powder having a specific surface area of 200 m²/g, measured by a BET method, by dry blending with a Henschel mixer (manufactured by Mitsui Mining Co., Ltd.).

### Example 10

A binder resin (polyester resin) (Tg: 55° C., acid value: 20 mg KOH/g, hydroxyl value: 16 mg KOH/g, molecular weight: Mp=4500, Mn=2300, Mw=38000): 100 parts by mass, C.I. Pigment Yellow 155 (manufactured by Clariant, trade name: “Toner Yellow 3GP”): 3 parts by mass, Compound (4): 3 parts by mass, aluminum 1,4-di-t-butylsalicylate compound: 0.5 parts by mass, and paraffin wax (maximum endothermic peak temperature: 78° C.): 5 parts by mass were sufficiently mixed with a Henschel mixer (model FM-75J, manufactured by Mitsui Mining Co., Ltd.). The mixture was kneaded with a biaxial kneader (model PCM-45, manufactured by Ikegai Corp.) heated to 130° C. at a feeding rate of 60 kg/hr (the temperature of kneaded product when it was discharged was about 150° C.). The kneaded product was cooled, was roughly pulverized with a hammer mill, and was then finely pulverized with a mechanical pulverizer (T-250, manufactured by Freund-Turbo Corporation) at a feeding rate of 20 kg/hr.

The finely pulverized toner product was further classified with a multi-division classifier utilizing the Coanda effect to give toner particles.

Yellow toner (10) was prepared by mixing 100 parts by mass of the resulting toner particles with 1.8 parts by mass of a hydrophobized silica fine powder having a specific surface area of 200 m²/g, measured by a BET method, by dry blending with a Henschel mixer (manufactured by Mitsui Mining Co., Ltd.).

### Examples 11 to 13

Yellow toners (11) to (13) were prepared as in Example 1 except that 6 parts by mass of Compound (28), 6 parts by mass of Compound (29), and 6 parts by mass of Compound (30) were respectively used in place of 5 parts by mass of Compound (1) in Example 1.

### (1) Measurement of Weight-Average Particle Diameter (D4) and Number-Average Particle Diameter (D1) of Yellow Toner

The number-average particle diameter (D1) and the weight-average particle diameter (D4) of each yellow toner were measured by particle size distribution analysis according to a Coulter method. The measurement was performed with Coulter Counter TA-II or Coulter Multisizer II (manufactured by Beckman Coulter, Inc.) in accordance with the operation manual of the apparatus. An about 1% aqueous solution of sodium chloride was prepared with primary sodium chloride as an electrolytic solution. For example, ISOTON-II (manufactured by Coulter Scientific Japan) can be used. Specifically, 0.1 to 5 mL of a surfactant (e.g., alkylbenzenesulfonate) is added to 100 to 150 mL of the aqueous electrolyte solution, and 2 to 20 mg of a sample (toner) to be measured is added thereto. The electrolytic solution suspending the sample is subjected to dispersing treatment with a supersonic disperser for about 1 to 3 minutes. The dispersion-treated solution was subjected to measurement of the volume and the number of toner particles having a size of 2.00 μm or more with the measurement apparatus equipped with apertures of 100 μm to calculate the volume distribution and the number distribution of each toner. The number-average particle diameter (D1) determined from the number distribution of a toner and the weight-average particle diameter (D4) determined from the volume distribution of the toner (the median value of each channel is defined as the representative value of the channel) and the ratio D4/D1 were determined.

As the channels, 13 channels: 2.00 to 2.52 μm, 2.52 to 3.17 μm, 3.17 to 4.00 μm, 4.00 to 5.04 μm, 5.04 to 6.35 μm, 6.35 to 8.00 μm, 8.00 to 10.08 μm, 10.08 to 12.70 μm, 12.70 to 16.00 μm, 16.00 to 20.20 μm, 20.20 to 25.40 μm, 25.40 to 32.00 μm, and 32.00 to 40.30 μm were used.

Evaluation was performed as below, and particle distribution showing a ratio D4/D1 of less than 1.35 was determined as to be satisfactory.

A: the ratio D4/D1 is less than 1.30,

B: the ratio D4/D1 is 1.30 or higher and less than 1.35, and

C: the ratio D4/D1 is 1.35 or higher.

(2) Evaluation of Image Sample Printed with Yellow Toner

Image samples were printed using the yellow toners (1) to (13) and (comparative 1) to (comparative 3), and image characteristics described below were comparatively evaluated. In the comparison of image characteristics, an image formation device, LBP-5300 (manufactured by CANON

KABUSHIKI KAISHA) that was modified such that the developing blade in the process cartridge (hereinafter referred to as CRG) was replaced with an SUS blade having a thickness of 8 μm, was used. The device was checked for the paper-feeding durability before the comparative evaluation. In addition, the device was modified such that a blade bias of −200 V can be applied to the developing bias applied to the developing roller, which is a toner support.

The evaluation was performed using the CRG filled with the individual yellow toner for each evaluation item. The CRG filled with a toner was set to the image formation device, and the following evaluation items were evaluated.

The image sample of each of the yellow toners (1) to (13) and (comparative 1) to (comparative 3) was measured for chromaticity (L*, a*, b*) in the L*a*b* color system with a reflection densitometer SpectroLino (manufactured by Gretag Macbeth AG).

### Evaluation of Light Resistance of Toner

Each of the image samples prepared in the chromaticity measurement was charged in a xenon tester (Atlas Ci4000, manufactured by Suga Test Instruments Co., Ltd.) and was subjected to exposure conditions (irradiance: 0.39 W/m² at 340 nm, temperature: 40° C., relative humidity: 60%) for 30 hours. The reflection densities of printed matters were measured before and after the test. The color difference AE was calculated from the initial chromaticity values a₀*, b₀*, and L₀* and the chromaticity values a*, b*, and L* after the exposure by the following expression:

ΔE=\sqrt{(a*−a_{O}*)²+(b*−b_{O}*)²+(L*−L_{O}*)²} [Math. 1]

The results are shown in Table 1.

The evaluation criteria are as follows:

A: ΔE<3.0

B: 3.0≦ΔE≦5.0

C, 5.0≦ΔE

The evaluation results of Examples and Comparative Examples are summarized in Table 1. In Table 1, PY185, PY180, and PY155 refer to C.I. Pigment Yellow 185, C.I. Pigment Yellow 180, and C.I. Pigment Yellow 155, respectively.

TABLE 1

| | | | | | Evaluation of | | Evaluation of | |
|---|---|---|---|---|---|---|---|---|
| | | | | | particle distribution | | light resistance | |
| | | | Method of | D4 | | Evaluation | | Evaluation |
| | Toner No. | Compound No. | producing toner | (μm) | D4/D1 | results | ΔE | results |
| Example 1 | Yellow toner (1) | Compound (1) | suspension | 6.21 | 1.34 | B | 3.8 | B |
| | | | polymerization | | | | | |
| Example 2 | Yellow toner (2) | Compound (4) | suspension | 5.99 | 1.29 | A | 1.6 | A |
| | | | polymerization | | | | | |
| Example 3 | Yellow toner (3) | Compound (13) | suspension | 5.76 | 1.30 | B | 2.5 | A |
| | | | polymerization | | | | | |
| Example 4 | Yellow toner (4) | Compound (1) | emulsion | 6.38 | 1.27 | A | 4.9 | B |
| | | | aggregation | | | | | |
| Example 5 | Yellow toner (5) | Compound (15) | emulsion | 6.92 | 1.21 | A | 4.3 | B |
| | | | aggregation | | | | | |
| Example 6 | Yellow toner (6) | Compound (8) | pulverization | 7.03 | 1.22 | A | 2.6 | A |
| Example 7 | Yellow toner (7) | Compound (23) | pulverization | 6.48 | 1.24 | A | 3.3 | B |
| Example 8 | Yellow toner (8) | PY185 | suspension | 5.84 | 1.30 | B | 1.6 | A |
| | | Compound (1) | polymerization | | | | | |
| Example 9 | Yellow toner (9) | PY180 | emulsion | 6.39 | 1.25 | A | 4.4 | B |
| | | Compound (15) | aggregation | | | | | |
| Example 10 | Yellow toner (10) | PY155 | pulverization | 6.05 | 1.19 | A | 2.9 | A |
| | | Compound (4) | | | | | | |
| Example 11 | Yellow toner (11) | Compound (28) | suspension | 6.67 | 1.34 | B | 1.7 | A |
| | | | polymerization | | | | | |
| Example 12 | Yellow toner (12) | Compound (29) | suspension | 6.33 | 1.28 | A | 2.8 | A |
| | | | polymerization | | | | | |
| Example 13 | Yellow toner (13) | Compound (30) | suspension | 6.24 | 1.31 | B | 3.8 | B |
| | | | polymerization | | | | | |
| Comparative | Yellow toner | Comparative | suspension | 7.42 | 1.42 | C | 9.7 | C |
| Example 1 | (Comparative 1) | Compound (1) | polymerization | | | | | |
| Comparative | Yellow toner | Comparative | emulsion | 6.21 | 1.21 | A | 6.8 | C |
| Example 2 | (Comparative 2) | Compound (2) | aggregation | | | | | |
| Comparative | Yellow toner | Comparative | pulverization | 6.94 | 1.33 | B | 8.4 | C |
| Example 3 | (Comparative 3) | Compound (1) | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-144317, filed Jun. 27, 2012, which is hereby incorporated by reference herein in its entirety.

1. A yellow toner comprising toner particles, each of which comprises a binder resin, a wax, and a colorant, wherein
the colorant is a compound represented by Formula (1): 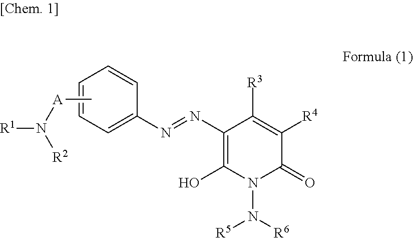
wherein,
R¹ and R² each independently represent a hydrogen atom or an alkyl group;
R³ represents an alkyl group, an aryl group, or an amino group;
R⁴ represents a hydrogen atom, a cyano group, a carbamoyl group, an alkoxycarbonyl group, or a carboxylic acid amide group;
R⁵ and R⁶ each independently
represents a hydrogen atom, an alkyl group, or an acyl group or
represents an atomic group required to form a nitrogen-containing heterocyclic ring by bonding to each other; and
A represents a carbonyl group or a sulfonyl group.

2. The yellow toner according to claim 1, wherein R¹ and R² in Formula (1) each independently represent a hydrogen atom, a methyl group, an ethyl group, an n-butyl group, an n-octyl group, or a 2-ethylhexyl group.

3. The yellow toner according to claim 1, wherein R³ in Formula (1) represents an alkyl group.

4. The yellow toner according to claim 1, wherein R⁴ in Formula (1) represents a cyano group.

5. The yellow toner according to claim 1, wherein R⁵ and R⁶ in Formula (1) each independently
represents a hydrogen atom, a methyl group, an ethyl group, an n-butyl group, a 2-ethylhexanoyl group, a benzoyl group, or a tert-butynoyl group or
represents an atomic group required to form a piperidine ring by bonding to each other.

6. The yellow toner according to claim 1, wherein the colorant further comprises C.I. Pigment Yellow 185, C.I. Pigment Yellow 180, or C.I. Pigment Yellow 155.

7. The yellow toner according to claim 1, wherein the yellow toner has a ratio (D4/D1) of the weight-average particle diameter (D4) to the number-average particle diameter (D1) of 1.35 or less.

8. The yellow toner according to claim 1, wherein the toner particle is produced by suspension polymerization.
